(19) United States
(12) Patent Application Publication
(10) Pub. No.: US 2026/0056410 A1
(43) Pub. Date: Feb. 26, 2026

(54) SLANTED GRATING FABRICATION

(71) Applicant: Magic Leap, Inc., Plantation, FL (US)

(72) Inventors: Shuqiang YANG, Austin, TX (US); Frank Y. XU, Austin, TX (US)

(21) Appl. No.: 19/105,600

(22) PCT Filed: Oct. 14, 2022
(86) PCT No.: PCT/US2022/078124

§ 371 Date: Feb. 21, 2025

(51) Int. Cl. G02B 27/01; G02B 5/18

(52) U.S. Cl. CPC G02B 27/0172; G02B 5/1857; G02B 5/1866; G02B 2027/0178

(57) ABSTRACT

A method includes patterning a plurality of first trenches in a surface of a substrate; and etching the plurality of first trenches with an etchant having an etch rate for a first crystalline plane of the substrate that is greater than for a second crystalline plane of the substrate. The etching forms a slanted grating in the substrate.

### FIELD OF THE DISCLOSURE

The present disclosure relates to optical components for display systems, such as for augmented and virtual reality display systems

### BACKGROUND

Modern computing and display technologies have facilitated the development of systems for so-called “virtual reality” or “augmented reality” experiences, in which digitally reproduced images or portions thereof are presented to a user in a manner such that they seem to be, or may be perceived as, real. A virtual reality, or “VR”, scenario typically involves presentation of digital or virtual image information without transparency to other actual real-world visual input; an augmented reality, or “AR”, scenario typically involves presentation of digital or virtual image information as an augmentation to visualization of the actual world around the user. A mixed reality, or “MR”, scenario is a type of AR scenario and typically involves virtual objects that are integrated into, and responsive to, the natural world. For example, in an MR scenario, AR image content may be blocked by or otherwise be perceived as interacting with objects in the real world.

Referring to FIG. 1, an augmented reality scene 10 is depicted in which a user of an AR technology sees a real-world park-like setting 20 featuring people, trees, buildings in the background, and a concrete platform 30. In addition to these items, the user of the AR technology also perceives that he “sees” “virtual content” such as a robot statue 40 standing upon the real-world platform 30, and a cartoon-like avatar character 50 flying by which seems to be a personification of a bumble bee, even though these elements 40, 50 do not exist in the real world. Because the human visual perception system is complex, it can be challenging to produce an AR technology that facilitates a comfortable, natural-feeling, rich presentation of virtual image elements amongst other virtual or real-world imagery elements.

Systems and methods disclosed herein address various challenges related to AR and VR technology.

### SUMMARY

Some aspects of this disclosure describe a method. The method includes patterning a plurality of first trenches in a surface of a substrate; and etching the plurality of first trenches with an etchant having an etch rate for a first crystalline plane of the substrate that is greater than for a second crystalline plane of the substrate. The etching forms a slanted grating in the substrate.

This and other described methods can have one or more of at least the following characteristics.

In some embodiments, sidewalls of the slanted grating are defined by the second crystalline plane.

In some embodiments, the substrate has a diamond cubic crystal structure, and the second crystalline plane is a {1 1 1} plane of the diamond cubic crystal structure.

In some embodiments, the substrate includes a silicon substrate or a germanium substrate.

In some embodiments, the etchant includes potassium hydroxide (KOH) or tetramethylammonium hydroxide (TMAH).

In some embodiments, the slanted grating is formed by a plurality of second trenches. The second trenches have a depth extending into the surface of the substrate, a width extending between two sidewalls defined by the {1 1 1} plane, and a length that is greater than the width. The length extends parallel to a <1 1 0> direction of the diamond cubic crystal structure.

In some embodiments, the width extends parallel to a <2 −1 −1> direction of the diamond cubic crystal structure.

In some embodiments, the substrate includes a (1 1 1)-oriented substrate, and sidewalls of the slanted grating have a slant angle of about 19.5° degrees.

In some embodiments, a normal direction to the surface of the substrate has a first angle of 19.5°−θ° with respect to the {1 1 1} plane of the diamond cubic crystal structure. The sidewalls of the slanted grating have a slant angle equal to the first angle, and 0°<θ°<19.5°.

In some embodiments, a normal direction to the surface of the substrate has a first angle of 19.5°+θ with respect to the {1 1 1} plane of the diamond cubic crystal structure. The sidewalls of the slanted grating have a slant angle equal to the first angle, and θ°>0°.

In some embodiments, the surface of the substrate is sloped, with respect to a (1 1 1) plane of the diamond cubic crystal structure, in a <2 −1 −1> direction of the diamond cubic crystal structure.

In some embodiments, patterning the plurality of first trenches in the surface of the substrate includes: forming a mask on the surface of the substrate; and anisotropically etching the substrate through openings in the mask, to form the plurality of first trenches.

In some embodiments, each trench of the plurality of first trenches has vertical sidewalls.

In some embodiments, anisotropically etching the substrate includes plasma-etching the substrate.

In some embodiments, the method includes, subsequent to etching the plurality of first trenches, removing the mask from the surface of the substrate.

In some embodiments, the method includes, subsequent to patterning the plurality of first trenches, and prior to etching the plurality of first trenches, removing a portion of the mask adjacent to at least one first trench of the plurality of first trenches.

In some embodiments, bases of the slanted grating are defined by the second crystalline plane.

In some embodiments, the slanted grating is formed by a plurality of second trenches. The second trenches have a width extending between two sidewalls defined by the second crystalline plane, and the width is between 50 nm and 1 μm.

In some embodiments, the slanted grating has a pitch between 20 μm and 200 μm.

In some embodiments, the slanted grating is formed by a plurality of second trenches, and a depth of the second trenches is between 50 nm and 1 μm.

In some embodiments, the method includes imprinting a replication material using the slanted grating as a mold, to form a corresponding slanted grating in the replication material.

In some embodiments, the method includes determining a target width of second trenches of the slanted grating; determining a first width based on the target width and a predetermined change in width caused by the etchant; and patterning the plurality of first trenches to have the first width.

Some aspects of this disclosure describe another method. The method includes providing a master template substrate; forming a slanted diffraction grating pattern in a surface of the master template substrate; and using the master template substrate having the slanted diffraction grating pattern to imprint the slanted diffraction grating pattern on a device substrate.

This and other described methods can have one or more of at least the following characteristics.

In some embodiments, the master template substrate has a diamond cubic crystal structure, and the slanted diffraction grating pattern is defined by a first {1 1 1} plane of the diamond cubic crystal structure.

In some embodiments, the method includes forming a second slanted diffraction grating pattern in the surface of the master template substrate, the second slanted diffraction grating pattern defined by a second {1 1 1} plane of the diamond cubic crystal structure, the second {1 1 1} plane different from the first {1 1 1} plane.

In some embodiments, sidewalls of the slanted diffraction grating pattern are defined by a crystalline plane of the master template substrate.

In some embodiments, the slanted diffraction grating pattern is a first slanted diffraction grating pattern, and the method includes: forming a second slanted diffraction grating pattern in the surface of the master template substrate, where the first slanted diffraction grating pattern and the second slanted diffraction grating pattern have different array directions; and using the master template substrate to imprint the second slanted diffraction grating pattern on the device substrate.

Some aspects of this disclosure describe another method. The method includes determining a target slant angle for a slanted grating; determining, based on a crystal structure of a material, a substrate orientation corresponding to the target slant angle; providing a substrate having the determined substrate orientation, the substrate composed of the material; and forming the slanted grating in a surface of the substrate.

In some embodiments, providing the substrate having the determined substrate orientation includes: determining a cutting angle based on the substrate orientation; and slicing an ingot of the material at the cutting angle, to obtain, sliced from the ingot, the substrate having the determined substrate orientation.

Some aspects of this disclosure describe another method. The method includes providing a substrate including a first set of parallel trenches and a second set of parallel trenches; and etching the first set of parallel trenches to form a first slanted grating, and etching the second set of trenches to form a second slanted grating. The first slanted grating includes first trenches, each first trench having a first width defined by two first crystalline planes and a first length that is longer than the first width. The second slanted grating includes second trenches, each second trench having a second width defined by two second crystalline planes and a second length that is longer than the second width. The first length and the second length extend in different directions.

This and other described methods can have one or more of at least the following characteristics.

In some embodiments, etching the first set of parallel trenches and etching the second set of trenches are performed in a common, simultaneous etch process.

In some embodiments, the substrate has a diamond cubic crystal structure.

The first crystalline planes are a first {1 1 1} plane, and the second crystalline planes are a second {1 1 1} plane that is different from the first {1 1 1} plane.

Some aspects of this disclosure describe an optical device. The optical device includes a waveguide, and a slanted grating arranged to direct light into the waveguide, the slanted grating having a slant angle of 19.5°.

Some aspects of this disclosure describe an optical device. The optical device includes a waveguide, and a slanted grating defined in a surface of a substrate, the slanted grating arranged to direct light into the waveguide. Sidewalls of the slanted grating are defined by a crystalline plane of the substrate.

In some embodiments, the substrate has a diamond cubic crystal structure, and the sidewalls are defined by a {1 1 1} plane of the diamond cubic crystal structure.

In some embodiments, the substrate includes the waveguide.

Some aspects of this disclosure describe a display system. The display system includes a waveguide, and a light-coupling element including a slanted grating. The slanted grating is fabricated in a process that includes etching a substrate with an etchant having an etch rate for a first crystalline plane of the substrate that is greater than for a second crystalline plane of the substrate.

This and other described display systems can have one or more of at least the following characteristics.

In some embodiments, the display system includes a virtual reality (VR) or augmented reality (AR) display system.

In some embodiments, the substrate includes the waveguide.

In some embodiments, the process forms a master template slanted grating in the substrate, and the slanted grating of the light-coupling element is formed in a replication material by imprinting the replication material with the master template slanted grating.

The slanted grating of the light-coupling element can be any of the slanted gratings illustrated and/or described throughout this disclosure (e.g., slanted gratings 1122, 1522, or 1822), and/or a slanted grating formed by using one of those slanted gratings as a master template to imprint the slanted grating in a device substrate. The process to form the slanted grating can include any of the processes illustrated and/or described throughout this disclosure, such as the processes illustrated in FIGS. 11A-11E, 15A-15B, 17A-17D, 18A-18C, 19A-19B, 20, or 21A-21B.

The details of one or more embodiments are set forth in the accompanying drawings and the description below. Other aspects, features and advantages will be apparent from the description and drawings, and from the claims.

### BRIEF DESCRIPTION OF THE DRAWINGS

FIG. 1 illustrates a user's view of augmented reality (AR) through an AR device.

FIG. 2 illustrates a conventional display system for simulating three-dimensional imagery for a user.

FIGS. 3A-3C illustrate relationships between radius of curvature and focal radius.

FIG. 4A illustrates a representation of the accommodation-vergence response of the human visual system.

FIG. 4B illustrates examples of different accommodative states and vergence states of a pair of eyes of the user.

FIG. 4C illustrates an example of a representation of a top-down view of a user viewing content via a display system.

FIG. 4D illustrates another example of a representation of a top-down view of a user viewing content via a display system.

FIG. 5 illustrates aspects of an approach for simulating three-dimensional imagery by modifying wavefront divergence.

FIG. 6 illustrates an example of a waveguide stack for outputting image information to a user.

FIG. 7 illustrates an example of exit beams outputted by a waveguide.

FIG. 8 illustrates an example of a stacked waveguide assembly in which each depth plane includes images formed using multiple different component colors.

FIG. 9A illustrates a cross-sectional side view of an example of a set of stacked waveguides that each includes an incoupling optical element.

FIG. 9B illustrates a perspective view of an example of the plurality of stacked waveguides of FIG. 9A.

FIG. 9C illustrates a top-down plan view of an example of the plurality of stacked waveguides of FIGS. 9A and 9B.

FIG. 9D illustrates an example of a wearable display system.

FIG. 10A illustrates an example of a slanted grating.

FIG. 10B illustrates an example of a display device including a slanted grating.

FIGS. 11A-11E illustrate an example of a process for fabricating slanted gratings.

FIGS. 12A-12B illustrate an example of a substrate having an orientation suitable for slanted grating fabrication.

FIG. 13 is a scanning electron microscopy image of a slanted grating.

FIGS. 14A-14B illustrate an example of substrate orientation based on a cutting angle.

FIGS. 15A-15B illustrate an example of a process for fabricating slanted gratings.

FIGS. 16A-16B illustrate an example of substrate orientation based on a cutting angle.

FIGS. 17A-17D illustrate an example of a process for fabricating slanted gratings.

FIGS. 18A-18C illustrate an example of a process for fabricating slanted gratings.

FIGS. 19A-19B illustrate an example of an imprint process.

FIG. 20 illustrates an example of a process for fabricating slanted gratings.

FIGS. 21A-21B illustrate an example of a process for fabricating slanted gratings.

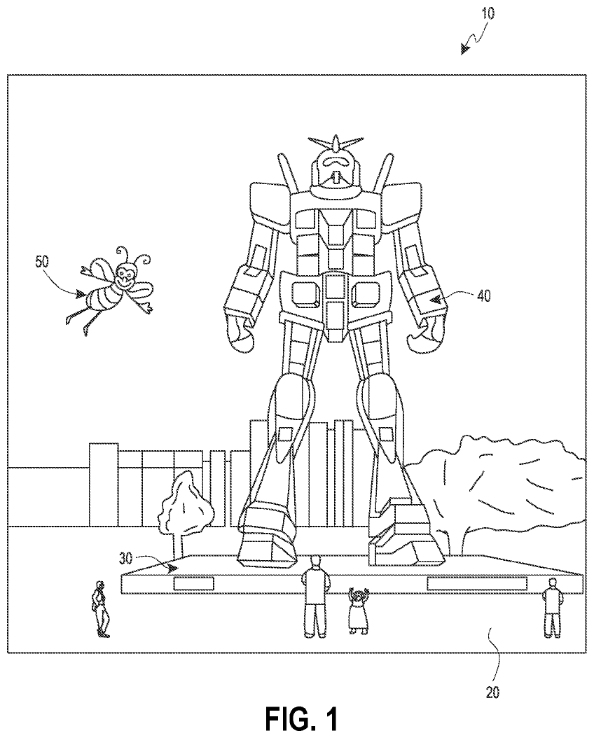

### DETAILED DESCRIPTION

AR systems may display virtual content to a user, or viewer, while still allowing the user to see the world around them. Preferably, this content is displayed on a head-mounted display, e.g., as part of eyewear, that projects image information to the user's eyes. In addition, the display may also transmit light from the surrounding environment to the user's eyes, to allow a view of that surrounding environment. As used herein, it will be appreciated that a “head-mounted” or “head mountable” display is a display that may be mounted on the head of a viewer or user.

Various AR systems disclosed herein include a virtual/augmented/mixed display, which in turn can includes one or more optical elements formed on or as part of a waveguide. The optical elements may include, e.g., an in-coupling optical element that may be employed to couple light into a waveguide, and/or an out-coupling optical element that may be employed to couple light out of the waveguide and into the user's eyes. To achieve high efficiency in in-coupling of light into and/or out-coupling of light from the waveguide, optical elements may include diffraction gratings. In some display systems, a relatively high diffraction efficiency of the optical elements may be achieved in part by including a slanted grating, which is a type of diffraction grating that can provide high diffraction efficiency for in-coupled/out-coupled light. A slanted diffraction grating can be fabricated by imprinting a slanted diffraction grating pattern on a device substrate, e.g., a waveguide, using a device master template.

Reference will now be made to the drawings, in which like reference numerals refer to like parts throughout. Unless indicated otherwise, the drawings are schematic not necessarily drawn to scale.

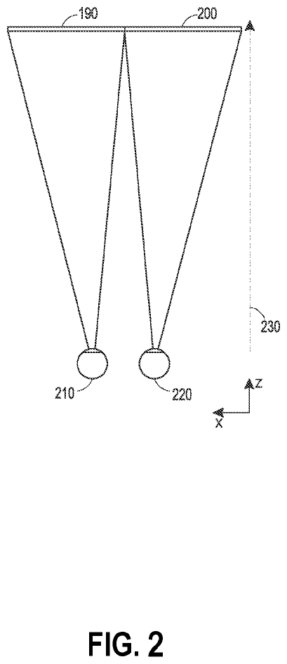

FIG. 2 illustrates a conventional display system for simulating three-dimensional imagery for a user. It will be appreciated that a user's eyes are spaced apart and that, when looking at a real object in space, each eye will have a slightly different view of the object and may form an image of the object at different locations on the retina of each eye. This may be referred to as binocular disparity and may be utilized by the human visual system to provide a perception of depth. Conventional display systems simulate binocular disparity by presenting two distinct images 190, 200 with slightly different views of the same virtual object—one for each eye 210, 220—corresponding to the views of the virtual object that would be seen by each eye were the virtual object a real object at a desired depth. These images provide binocular cues that the user's visual system may interpret to derive a perception of depth.

With continued reference to FIG. 2, the images 190, 200 are spaced from the eyes 210, 220 by a distance 230 on a z-axis. The z-axis is parallel to the optical axis of the viewer with their eyes fixated on an object at optical infinity directly ahead of the viewer. The images 190, 200 are flat and at a fixed distance from the eyes 210, 220. Based on the slightly different views of a virtual object in the images presented to the eyes 210, 220, respectively, the eyes may naturally rotate such that an image of the object falls on corresponding points on the retinas of each of the eyes, to maintain single binocular vision. This rotation may cause the lines of sight of each of the eyes 210, 220 to converge onto a point in space at which the virtual object is perceived to be present. As a result, providing three-dimensional imagery conventionally involves providing binocular cues that may manipulate the vergence of the user's eyes 210, 220, and that the human visual system interprets to provide a perception of depth.

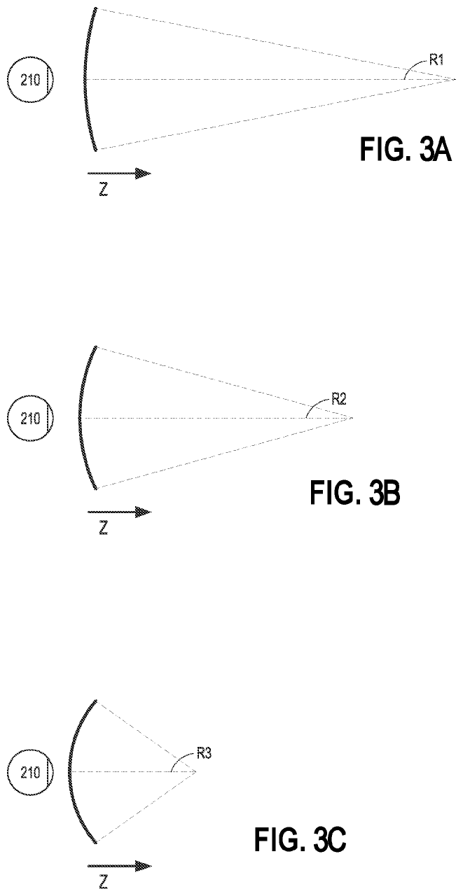

Generating a realistic and comfortable perception of depth is challenging, however. It will be appreciated that light from objects at different distances from the eyes have wavefronts with different amounts of divergence. FIGS. 3A-3C illustrate relationships between distance and the divergence of light rays. The distance between the object and the eye 210 is represented by, in order of decreasing distance, R1, R2, and R3. As shown in FIGS. 3A-3C, the light rays become more divergent as distance to the object decreases. Conversely, as distance increases, the light rays become more collimated. Stated another way, it may be said that the light field produced by a point (the object or a part of the object) has a spherical wavefront curvature, which is a function of how far away the point is from the eye of the user. The curvature increases with decreasing distance between the object and the eye 210. While only a single eye 210 is illustrated for clarity of illustration in FIGS. 3A-3C and other figures herein, the discussions regarding eye 210 may be applied to both eyes 210 and 220 of a viewer.

With continued reference to FIGS. 3A-3C, light from an object that the viewer's eyes are fixated on may have different degrees of wavefront divergence. Due to the different amounts of wavefront divergence, the light may be focused differently by the lens of the eye, which in turn may require the lens to assume different shapes to form a focused image on the retina of the eye. Where a focused image is not formed on the retina, the resulting retinal blur acts as a cue to accommodation that causes a change in the shape of the lens of the eye until a focused image is formed on the retina. For example, the cue to accommodation may trigger the ciliary muscles surrounding the lens of the eye to relax or contract, thereby modulating the force applied to the suspensory ligaments holding the lens, thus causing the shape of the lens of the eye to change until retinal blur of an object of fixation is eliminated or minimized, thereby forming a focused image of the object offixation on the retina (e.g., fovea) of the eye. The process by which the lens of the eye changes shape may be referred to as accommodation, and the shape of the lens of the eye required to form a focused image of the object of fixation on the retina (e.g., fovea) of the eye may be referred to as an accommodative state.

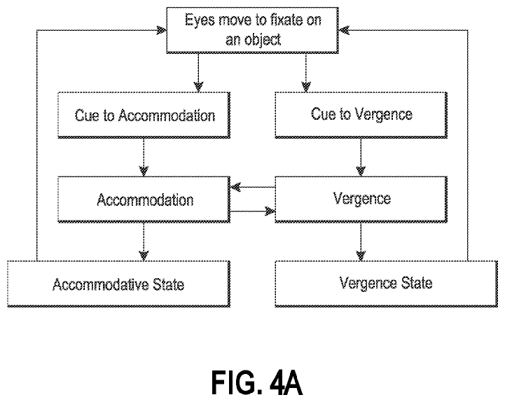

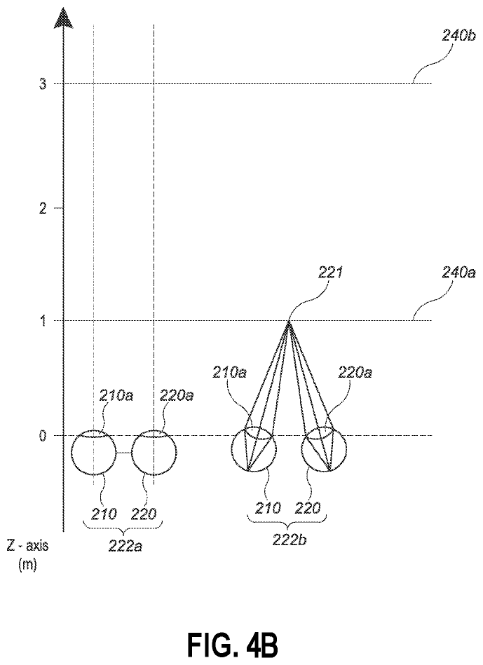

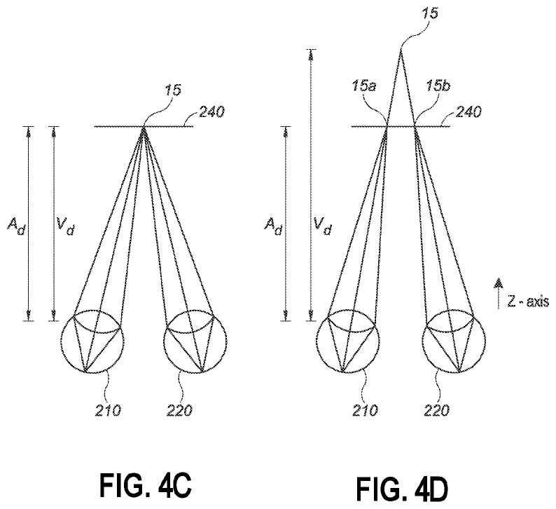

With reference now to FIG. 4A, a representation of the accommodation-vergence response of the human visual system is illustrated. The movement of the eyes to fixate on an object causes the eyes to receive light from the object, with the light forming an image on each of the retinas of the eyes. The presence of retinal blur in the image formed on the retina may provide a cue to accommodation, and the relative locations of the image on the retinas may provide a cue to vergence. The cue to accommodation causes accommodation to occur, resulting in the lenses of the eyes each assuming a particular accommodative state that forms a focused image of the object on the retina (e.g., fovea) of the eye. On the other hand, the cue to vergence causes vergence movements (rotation of the eyes) to occur such that the images formed on each retina of each eye are at corresponding retinal points that maintain single binocular vision. In these positions, the eyes may be said to have assumed a particular vergence state. With continued reference to FIG. 4A, accommodation may be understood to be the process by which the eye achieves a particular accommodative state, and vergence may be understood to be the process by which the eye achieves a particular vergence state. As indicated in FIG. 4A, the accommodative and vergence states of the eyes may change if the user fixates on another object. For example, the accommodated state may change if the user fixates on a new object at a different depth on the z-axis.

Without being limited by theory, it is believed that viewers of an object may perceive the object as being “three-dimensional” due to a combination of vergence and accommodation. As noted above, vergence movements (e.g., rotation of the eyes so that the pupils move toward or away from each other to converge the lines of sight of the eyes to fixate upon an object) of the two eyes relative to each other are closely associated with accommodation of the lenses of the eyes. Under normal conditions, changing the shapes of the lenses of the eyes to change focus from one object to another object at a different distance will automatically cause a matching change in vergence to the same distance, under a relationship known as the “accommodation-vergence reflex.” Likewise, a change in vergence will trigger a matching change in lens shape under normal conditions.

With reference now to FIG. 4B, examples of different accommodative and vergence states of the eyes are illustrated. The pair of eyes 222a is fixated on an object at optical infinity, while the pair eyes 222b are fixated on an object 221 at less than optical infinity. Notably, the vergence states of each pair of eyes is different, with the pair of eyes 222a directed straight ahead, while the pair of eyes 222 converge on the object 221. The accommodative states of the eyes forming each pair of eyes 222a and 222b are also different, as represented by the different shapes of the lenses 210a, 220a.

Undesirably, many users of conventional “3-D” display systems find such conventional systems to be uncomfortable or may not perceive a sense of depth at all due to a mismatch between accommodative and vergence states in these displays. As noted above, many stereoscopic or “3-D” display systems display a scene by providing slightly different images to each eye. Such systems are uncomfortable for many viewers, since they, among other things, simply provide different presentations of a scene and cause changes in the vergence states of the eyes, but without a corresponding change in the accommodative states of those eyes. Rather, the images are shown by a display at a fixed distance from the eyes, such that the eyes view all the image information at a single accommodative state. Such an arrangement works against the “accommodation-vergence reflex” by causing changes in the vergence state without a matching change in the accommodative state. This mismatch is believed to cause viewer discomfort. Display systems that provide a better match between accommodation and vergence may form more realistic and comfortable simulations of three-dimensional imagery.

Without being limited by theory, it is believed that the human eye typically may interpret a finite number of depth planes to provide depth perception. Consequently, a highly believable simulation of perceived depth may be achieved by providing, to the eye, different presentations of an image corresponding to each of these limited numbers of depth planes. In some embodiments, the different presentations may provide both cues to vergence and matching cues to accommodation, thereby providing physiologically correct accommodation-vergence matching.

With continued reference to FIG. 4B, two depth planes 240, corresponding to different distances in space from the eyes 210, 220, are illustrated. For a given depth plane 240, vergence cues may be provided by the displaying of images of appropriately different perspectives for each eye 210, 220. In addition, for a given depth plane 240, light forming the images provided to each eye 210, 220 may have a wavefront divergence corresponding to a light field produced by a point at the distance of that depth plane 240.

In the illustrated embodiment, the distance, along the z-axis, of the depth plane 240 containing the point 221 is 1 m. As used herein, distances or depths along the z-axis may be measured with a zero-point located at the exit pupils of the user's eyes. Thus, a depth plane 240 located at a depth of 1 m corresponds to a distance of 1 m away from the exit pupils of the user's eyes, on the optical axis of those eyes with the eyes directed towards optical infinity. As an approximation, the depth or distance along the z-axis may be measured from the display in front of the user's eyes (e.g., from the surface of a waveguide), plus a value for the distance between the device and the exit pupils of the user's eyes. That value may be called the eye relief and corresponds to the distance between the exit pupil of the user's eye and the display worn by the user in front of the eye. In practice, the value for the eye relief may be a normalized value used generally for all viewers. For example, the eye relief may be assumed to be 20 mm and a depth plane that is at a depth of 1 m may be at a distance of 980 mm in front of the display.

With reference now to FIGS. 4C and 4D, examples of matched accommodation-vergence distances and mismatched accommodation-vergence distances are illustrated, respectively. As illustrated in FIG. 4C, the display system may provide images of a virtual object to each eye 210, 220. The images may cause the eyes 210, 220 to assume a vergence state in which the eyes converge on a point 15 on a depth plane 240. In addition, the images may be formed by a light having a wavefront curvature corresponding to real objects at that depth plane 240. As a result, the eyes 210, 220 assume an accommodative state in which the images are in focus on the retinas of those eyes. Thus, the user may perceive the virtual object as being at the point 15 on the depth plane 240.

It will be appreciated that each of the accommodative and vergence states of the eyes 210, 220 are associated with a particular distance on the z-axis. For example, an object at a particular distance from the eyes 210, 220 causes those eyes to assume particular accommodative states based upon the distances of the object. The distance associated with a particular accommodative state may be referred to as the accommodation distance, Ad. Similarly, there are particular vergence distances, V_{d}, associated with the eyes in particular vergence states, or positions relative to one another. Where the accommodation distance and the vergence distance match, the relationship between accommodation and vergence may be said to be physiologically correct. This is considered to be the most comfortable scenario for a viewer.

In stereoscopic displays, however, the accommodation distance and the vergence distance may not always match. For example, as illustrated in FIG. 4D, images displayed to the eyes 210, 220 may be displayed with wavefront divergence corresponding to depth plane 240, and the eyes 210, 220 may assume a particular accommodative state in which the points 15a, 15b on that depth plane are in focus. However, the images displayed to the eyes 210, 220 may provide cues for vergence that cause the eyes 210, 220 to converge on a point 15 that is not located on the depth plane 240. As a result, the accommodation distance corresponds to the distance from the exit pupils of the eyes 210, 220 to the depth plane 240, while the vergence distance corresponds to the larger distance from the exit pupils of the eyes 210, 220 to the point 15, in some embodiments. The accommodation distance is different from the vergence distance. Consequently, there is an accommodation-vergence mismatch. Such a mismatch is considered undesirable and may cause discomfort in the user. It will be appreciated that the mismatch corresponds to distance (e.g., V_{d}−A_{d}) and may be characterized using diopters.

In some embodiments, it will be appreciated that a reference point other than exit pupils of the eyes 210, 220 may be utilized for determining distance for determining accommodation-vergence mismatch, so long as the same reference point is utilized for the accommodation distance and the vergence distance. For example, the distances could be measured from the cornea to the depth plane, from the retina to the depth plane, from the eyepiece (e.g., a waveguide of the display device) to the depth plane, and so on.

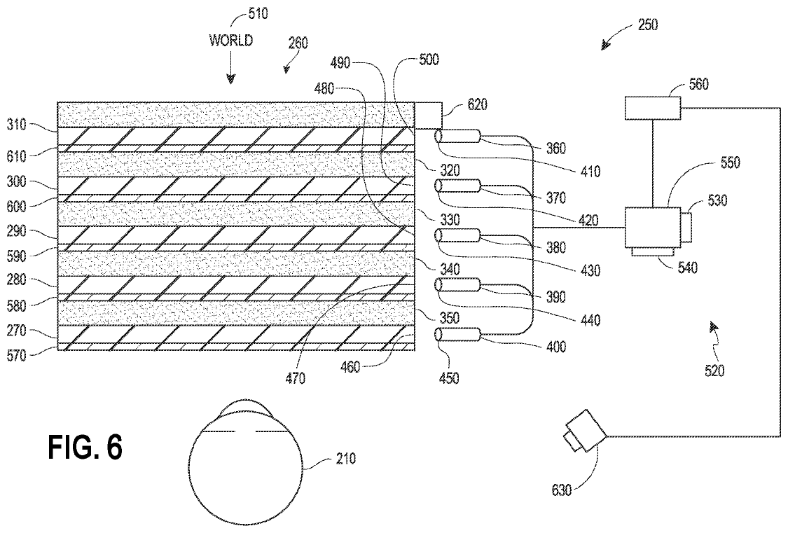

Without being limited by theory, it is believed that users may still perceive accommodation-vergence mismatches of up to about 0.25 diopter, up to about 0.33 diopter, and up to about 0.5 diopter as being physiologically correct, without the mismatch itself causing significant discomfort. In some embodiments, display systems disclosed herein (e.g., the display system 250, FIG. 6) present images to the viewer having accommodation-vergence mismatch of about 0.5 diopter or less. In some other embodiments, the accommodation-vergence mismatch of the images provided by the display system is about 0.33 diopter or less. In yet other embodiments, the accommodation-vergence mismatch of the images provided by the display system is about 0.25 diopter or less, including about 0.1 diopter or less.

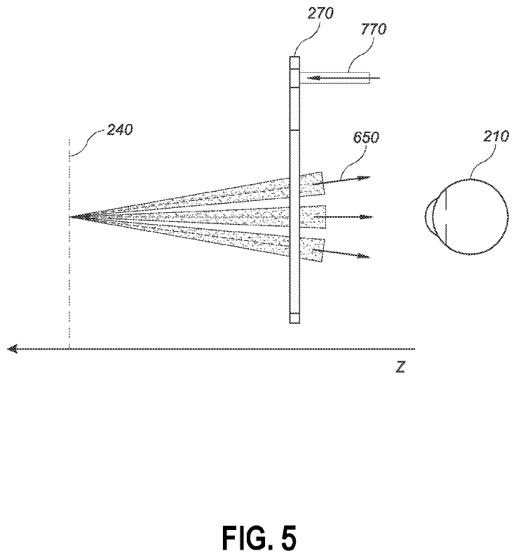

FIG. 5 illustrates aspects of an approach for simulating three-dimensional imagery by modifying wavefront divergence. The display system includes a waveguide 270 that is configured to receive light 770 that is encoded with image information, and to output that light to the user's eye 210. The waveguide 270 may output the light 650 with a defined amount of wavefront divergence corresponding to the wavefront divergence of a light field produced by a point on a desired depth plane 240. In some embodiments, the same amount of wavefront divergence is provided for all objects presented on that depth plane. In addition, it will be illustrated that the other eye of the user may be provided with image information from a similar waveguide.

In some embodiments, a single waveguide may be configured to output light with a set amount of wavefront divergence corresponding to a single or limited number of depth planes and/or the waveguide may be configured to output light of a limited range of wavelengths. Consequently, in some embodiments, a plurality or stack of waveguides may be utilized to provide different amounts of wavefront divergence for different depth planes and/or to output light of different ranges of wavelengths. As used herein, it will be appreciated at a depth plane may be planar or may follow the contours of a curved surface.

FIG. 6 illustrates an example of a waveguide stack for outputting image information to a user. A display system 250 includes a stack of waveguides, or stacked waveguide assembly, 260 that may be utilized to provide three-dimensional perception to the eye/brain using a plurality of waveguides 270, 280, 290, 300, 310. It will be appreciated that the display system 250 may be considered a light field display in some embodiments. In addition, the waveguide assembly 260 may also be referred to as an eyepiece.

In some embodiments, the display system 250 may be configured to provide substantially continuous cues to vergence and multiple discrete cues to accommodation. The cues to vergence may be provided by displaying different images to each of the eyes of the user, and the cues to accommodation may be provided by outputting the light that forms the images with selectable discrete amounts of wavefront divergence. Stated another way, the display system 250 may be configured to output light with variable levels of wavefront divergence. In some embodiments, each discrete level of wavefront divergence corresponds to a particular depth plane and may be provided by a particular one of the waveguides 270, 280, 290, 300, 310.

With continued reference to FIG. 6, the waveguide assembly 260 may also include a plurality of features 320, 330, 340, 350 between the waveguides. In some embodiments, the features 320, 330, 340, 350 may be one or more lenses. The waveguides 270, 280, 290, 300, 310 and/or the plurality of lenses 320, 330, 340, 350 may be configured to send image information to the eye with various levels of wavefront curvature or light ray divergence. Each waveguide level may be associated with a particular depth plane and may be configured to output image information corresponding to that depth plane. Image injection devices 360, 370, 380, 390, 400 may function as a source of light for the waveguides and may be utilized to inject image information into the waveguides 270, 280, 290, 300, 310, each of which may be configured, as described herein, to distribute incoming light across each respective waveguide, for output toward the eye 210. Light exits an output surface 410, 420, 430, 440, 450 of the image injection devices 360, 370, 380, 390, 400 and is injected into a corresponding input surface 460, 470, 480, 490, 500 of the waveguides 270, 280, 290, 300, 310. In some embodiments, each of the input surfaces 460, 470, 480, 490, 500 may be an edge of a corresponding waveguide, or may be part of a major surface of the corresponding waveguide (that is, one of the waveguide surfaces directly facing the world 510 or the viewer's eye 210). In some embodiments, a single beam of light (e.g. a collimated beam) may be injected into each waveguide to output an entire field of cloned collimated beams that are directed toward the eye 210 at particular angles (and amounts of divergence) corresponding to the depth plane associated with a particular waveguide. In some embodiments, a single one of the image injection devices 360, 370, 380, 390, 400 may be associated with and inject light into a plurality (e.g., three) of the waveguides 270, 280, 290, 300, 310.

In some embodiments, the image injection devices 360, 370, 380, 390, 400 are discrete displays that each produce image information for injection into a corresponding waveguide 270, 280, 290, 300, 310, respectively. In some other embodiments, the image injection devices 360, 370, 380, 390, 400 are the output ends of a single multiplexed display which may, e.g., pipe image information via one or more optical conduits (such as fiber optic cables) to each of the image injection devices 360, 370, 380, 390, 400. It will be appreciated that the image information provided by the image injection devices 360, 370, 380, 390, 400 may include light of different wavelengths, or colors (e.g., different component colors, as discussed herein).

In some embodiments, the light injected into the waveguides 270, 280, 290, 300, 310 is provided by a light projector system 520, which includes a light module 530, which may include a light emitter, such as a light emitting diode (LED). The light from the light module 530 may be directed to and modified by a light modulator 540, e.g., a spatial light modulator, via a beam splitter 550. The light modulator 540 may be configured to change the perceived intensity of the light injected into the waveguides 270, 280, 290, 300, 310 to encode the light with image information. Examples of spatial light modulators include liquid crystal displays (LCD) including a liquid crystal on silicon (LCOS) displays. It will be appreciated that the image injection devices 360, 370, 380, 390, 400 are illustrated schematically and, in some embodiments, these image injection devices may represent different light paths and locations in a common projection system configured to output light into associated ones of the waveguides 270, 280, 290, 300, 310. In some embodiments, the waveguides of the waveguide assembly 260 may function as ideal lens while relaying light injected into the waveguides out to the user's eyes. In this conception, the object may be the spatial light modulator 540 and the image may be the image on the depth plane.

In some embodiments, the display system 250 may be a scanning fiber display including one or more scanning fibers configured to project light in various patterns (e.g., raster scan, spiral scan, Lissajous patterns, etc.) into one or more waveguides 270, 280, 290, 300, 310 and ultimately to the eye 210 of the viewer. In some embodiments, the illustrated image injection devices 360, 370, 380, 390, 400 may schematically represent a single scanning fiber or a bundle of scanning fibers configured to inject light into one or a plurality of the waveguides 270, 280, 290, 300, 310. In some other embodiments, the illustrated image injection devices 360, 370, 380, 390, 400 may schematically represent a plurality of scanning fibers or a plurality of bundles of scanning fibers, each of which are configured to inject light into an associated one of the waveguides 270, 280, 290, 300, 310. It will be appreciated that one or more optical fibers may be configured to transmit light from the light module 530 to the one or more waveguides 270, 280, 290, 300, 310. It will be appreciated that one or more intervening optical structures may be provided between the scanning fiber, or fibers, and the one or more waveguides 270, 280, 290, 300, 310 to, e.g., redirect light exiting the scanning fiber into the one or more waveguides 270, 280, 290, 300, 310.

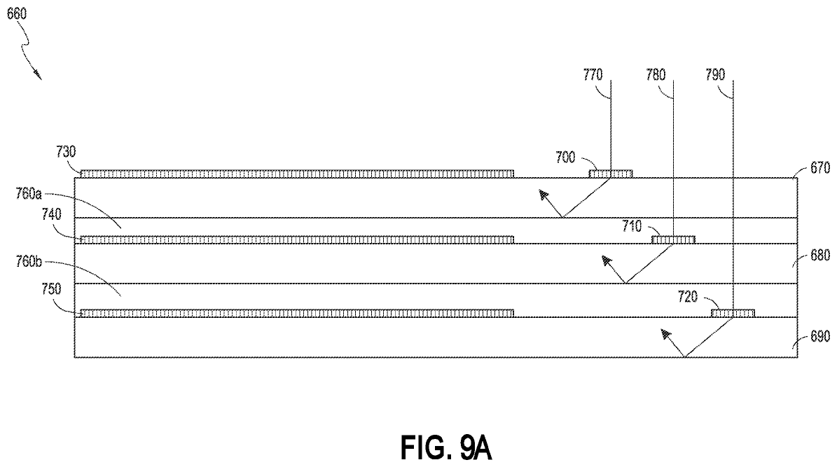

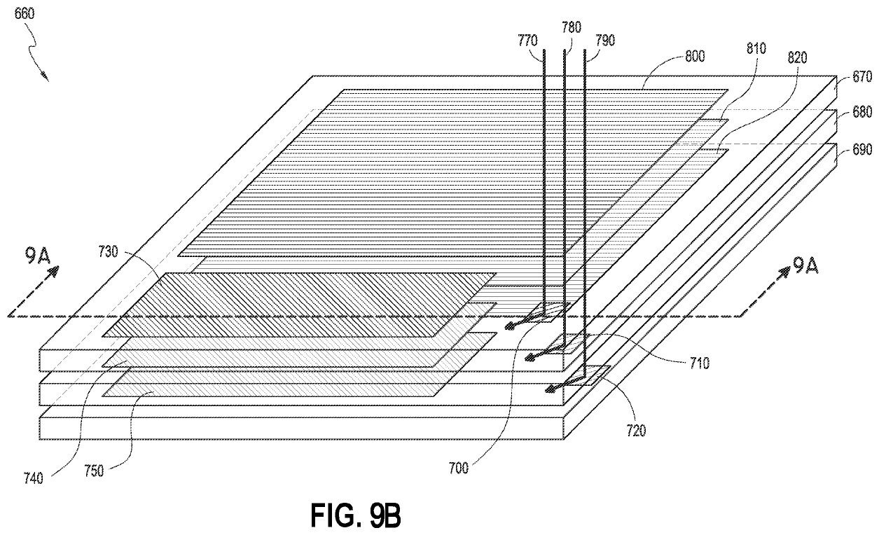

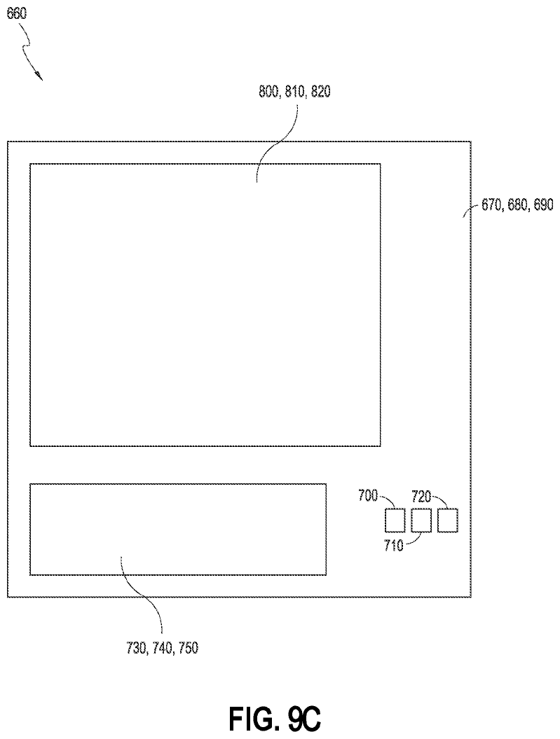

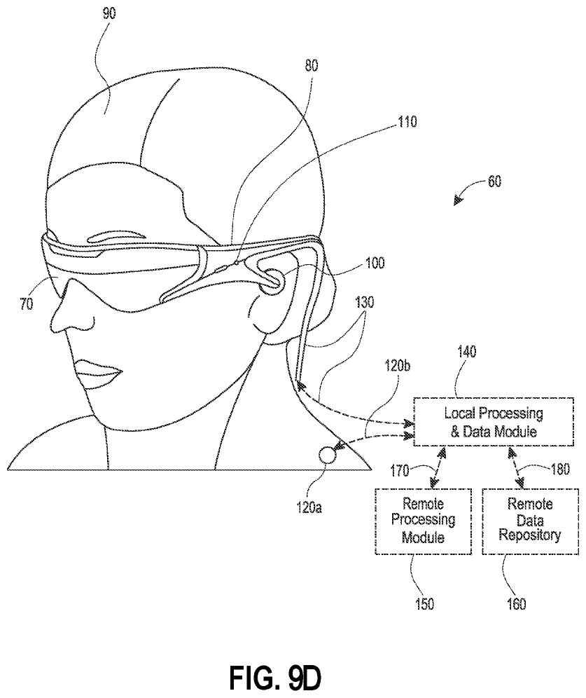

A controller 560 controls the operation of one or more of the stacked waveguide assembly 260, including operation of the image injection devices 360, 370, 380, 390, 400, the light source 530, and the light modulator 540. In some embodiments, the controller 560 is part of the local data processing module 140. The controller 560 includes programming (e.g., instructions in a non-transitory medium) that regulates the timing and provision of image information to the waveguides 270, 280, 290, 300, 310 according to, e.g., any of the various schemes disclosed herein. In some embodiments, the controller may be a single integral device, or a distributed system connected by wired or wireless communication channels. The controller 560 may be part of the processing modules 140 or 150 (FIG. 9D) in some embodiments.

With continued reference to FIG. 6, the waveguides 270, 280, 290, 300, 310 may be configured to propagate light within each respective waveguide by total internal reflection (TIR). The waveguides 270, 280, 290, 300, 310 may each be planar or have another shape (e.g., curved), with major top and bottom surfaces and edges extending between those major top and bottom surfaces. In the illustrated configuration, the waveguides 270, 280, 290, 300, 310 may each include out-coupling optical elements 570, 580, 590, 600, 610 that are configured to extract light out of a waveguide by redirecting the light, propagating within each respective waveguide, out of the waveguide to output image information to the eye 210. Extracted light may also be referred to as out-coupled light and the out-coupling optical elements light may also be referred to light extracting optical elements. An extracted beam of light may be outputted by the waveguide at locations at which the light propagating in the waveguide strikes a light extracting optical element. The out-coupling optical elements 570, 580, 590, 600, 610 may, for example, be gratings (e.g., any of the slanted gratings described herein, and/or slanted gratings formed using any of the processes described herein, including imprinting using a master template slanted grating fabricated as described herein), including diffractive optical features, as discussed further herein. While illustrated disposed at the bottom major surfaces of the waveguides 270, 280, 290, 300, 310, for ease of description and drawing clarity, in some embodiments, the out-coupling optical elements 570, 580, 590, 600, 610 may be disposed at the top and/or bottom major surfaces, and/or may be disposed directly in the volume of the waveguides 270, 280, 290, 300, 310, as discussed further herein. In some embodiments, the out-coupling optical elements 570, 580, 590, 600, 610 may be formed in a layer of material that is attached to a transparent substrate to form the waveguides 270, 280, 290, 300, 310. In some other embodiments, the waveguides 270, 280, 290, 300, 310 may be a monolithic piece of material and the out-coupling optical elements 570, 580, 590, 600, 610 may be formed on a surface and/or in the interior of that piece of material.

With continued reference to FIG. 6, as discussed herein, each waveguide 270, 280, 290, 300, 310 is configured to output light to form an image corresponding to a particular depth plane. For example, the waveguide 270 nearest the eye may be configured to deliver collimated light (which was injected into such waveguide 270), to the eye 210. The collimated light may be representative of the optical infinity focal plane. The next waveguide up 280 may be configured to send out collimated light which passes through the first lens 350 (e.g., a negative lens) before it may reach the eye 210; such first lens 350 may be configured to create a slight convex wavefront curvature so that the eye/brain interprets light coming from that next waveguide up 280 as coming from a first focal plane closer inward toward the eye 210 from optical infinity.

Similarly, the third up waveguide 290 passes its output light through both the first 350 and second 340 lenses before reaching the eye 210; the combined optical power of the first 350 and second 340 lenses may be configured to create another incremental amount of wavefront curvature so that the eye/brain interprets light coming from the third waveguide 290 as coming from a second focal plane that is even closer inward toward the person from optical infinity than was light from the next waveguide up 280.

The other waveguide layers 300, 310 and lenses 330, 320 are similarly configured, with the highest waveguide 310 in the stack sending its output through all of the lenses between it and the eye for an aggregate focal power representative of the closest focal plane to the person. To compensate for the stack of lenses 320, 330, 340, 350 when viewing/interpreting light coming from the world 510 on the other side of the stacked waveguide assembly 260, a compensating lens layer 620 may be disposed at the top of the stack to compensate for the aggregate power of the lens stack 320, 330, 340, 350 below. Such a configuration provides as many perceived focal planes as there are available waveguide/lens pairings. Both the out-coupling optical elements of the waveguides and the focusing aspects of the lenses may be static (i.e., not dynamic or electro-active). In some alternative embodiments, either or both may be dynamic using electro-active features.

In some embodiments, two or more of the waveguides 270, 280, 290, 300, 310 may have the same associated depth plane. For example, multiple waveguides 270, 280, 290, 300, 310 may be configured to output images set to the same depth plane, or multiple subsets of the waveguides 270, 280, 290, 300, 310 may be configured to output images set to the same plurality of depth planes, with one set for each depth plane. This may provide advantages for forming a tiled image to provide an expanded field of view at those depth planes.

With continued reference to FIG. 6, the out-coupling optical elements 570, 580, 590, 600, 610 may be configured to both redirect light out of their respective waveguides and to output this light with the appropriate amount of divergence or collimation for a particular depth plane associated with the waveguide. As a result, waveguides having different associated depth planes may have different configurations of out-coupling optical elements 570, 580, 590, 600, 610, which output light with a different amount of divergence depending on the associated depth plane. In some embodiments, the light extracting optical elements 570, 580, 590, 600, 610 may be volumetric or surface features, which may be configured to output light at specific angles. For example, the light extracting optical elements 570, 580, 590, 600, 610 may be volume holograms, surface holograms, and/or diffraction gratings. In some embodiments, the features 320, 330, 340, 350 may not be lenses; rather, they may simply be spacers (e.g., cladding layers and/or structures for forming air gaps).

In some embodiments, the out-coupling optical elements 570, 580, 590, 600, 610 are diffractive features that form a diffraction pattern, or “diffractive optical element” (also referred to herein as a “DOE”). Preferably, the DOE's have a sufficiently low diffraction efficiency so that only a portion of the light of the beam is deflected away toward the eye 210 with each intersection of the DOE, while the rest continues to move through a waveguide via TIR. The light carrying the image information is thus divided into a number of related exit beams that exit the waveguide at a multiplicity of locations and the result is a fairly uniform pattern of exit emission toward the eye 210 for this particular collimated beam bouncing around within a waveguide.

In some embodiments, one or more DOEs may be switchable between “on” states in which they actively diffract, and “off” states in which they do not significantly diffract. For instance, a switchable DOE may include a layer of polymer dispersed liquid crystal, in which microdroplets include a diffraction pattern in a host medium, and the refractive index of the microdroplets may be switched to substantially match the refractive index of the host material (in which case the pattern does not appreciably diffract incident light) or the microdroplet may be switched to an index that does not match that of the host medium (in which case the pattern actively diffracts incident light).

In some embodiments, a camera assembly 630 (e.g., a digital camera, including visible light and infrared light cameras) may be provided to capture images of the eye 210 and/or tissue around the eye 210 to, e.g., detect user inputs and/or to monitor the physiological state of the user. As used herein, a camera may be any image capture device. In some embodiments, the camera assembly 630 may include an image capture device and a light source to project light (e.g., infrared light) to the eye, which may then be reflected by the eye and detected by the image capture device. In some embodiments, the camera assembly 630 may be attached to the frame 80 (FIG. 9D) and may be in electrical communication with the processing modules 140 and/or 150, which may process image information from the camera assembly 630. In some embodiments, one camera assembly 630 may be utilized for each eye, to separately monitor each eye.

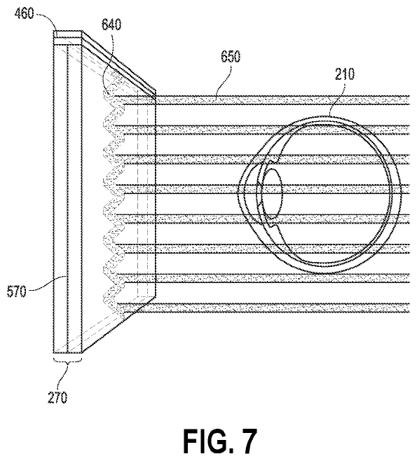

With reference now to FIG. 7, an example of exit beams outputted by a waveguide is shown. One waveguide is illustrated, but it will be appreciated that other waveguides in the waveguide assembly 260 (FIG. 6) may function similarly, where the waveguide assembly 260 includes multiple waveguides. Light 640 is injected into the waveguide 270 at the input surface 460 of the waveguide 270 and propagates within the waveguide 270 by TIR. At points where the light 640 impinges on the DOE 570, a portion of the light exits the waveguide as exit beams 650. The exit beams 650 are illustrated as substantially parallel but, as discussed herein, they may also be redirected to propagate to the eye 210 at an angle (e.g., forming divergent exit beams), depending on the depth plane associated with the waveguide 270. It will be appreciated that substantially parallel exit beams may be indicative of a waveguide with out-coupling optical elements that out-couple light to form images that appear to be set on a depth plane at a large distance (e.g., optical infinity) from the eye 210. Other waveguides or other sets of out-coupling optical elements may output an exit beam pattern that is more divergent, which would require the eye 210 to accommodate to a closer distance to bring it into focus on the retina and would be interpreted by the brain as light from a distance closer to the eye 210 than optical infinity.

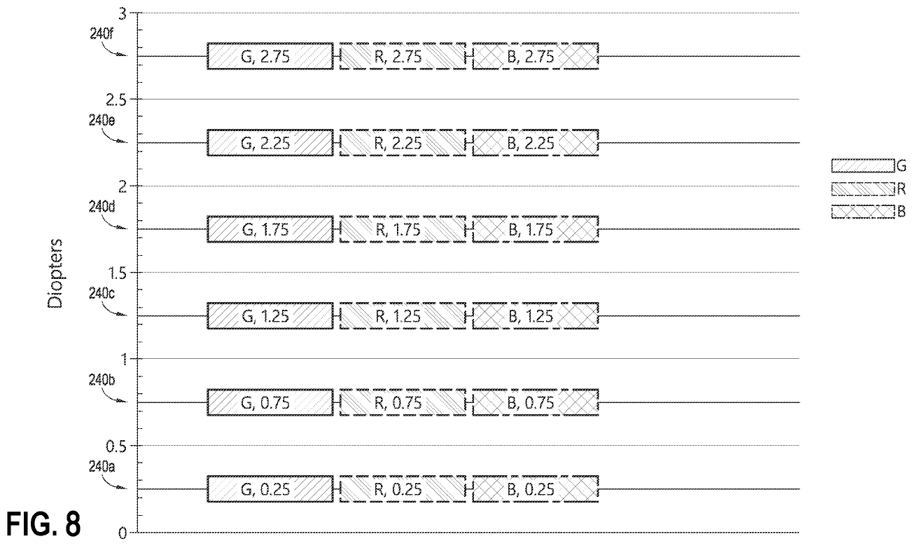

In some embodiments, a full color image may be formed at each depth plane by overlaying images in each of the component colors, e.g., three or more component colors. FIG. 8 illustrates an example of a stacked waveguide assembly in which each depth plane includes images formed using multiple different component colors. The illustrated embodiment shows depth planes 240a-240f, although more or fewer depths are also contemplated. Each depth plane may have three or more component color images associated with it, including: a first image of a first color, G; a second image of a second color, R; and a third image of a third color, B. Different depth planes are indicated in the figure by different numbers for diopters (dpt) following the letters G, R, and B. Just as examples, the numbers following each of these letters indicate diopters (l/m), or inverse distance of the depth plane from a viewer, and each box in the figures represents an individual component color image. In some embodiments, to account for differences in the eye's focusing of light of different wavelengths, the exact placement of the depth planes for different component colors may vary. For example, different component color images for a given depth plane may be placed on depth planes corresponding to different distances from the user. Such an arrangement may increase visual acuity and user comfort and/or may decrease chromatic aberrations.

In some embodiments, light of each component color may be outputted by a single dedicated waveguide and, consequently, each depth plane may have multiple waveguides associated with it. In such embodiments, each box in the figures including the letters G, R, or B may be understood to represent an individual waveguide, and three waveguides may be provided per depth plane where three component color images are provided per depth plane. While the waveguides associated with each depth plane are shown adjacent to one another in this drawing for ease of description, it will be appreciated that, in a physical device, the waveguides may all be arranged in a stack with one waveguide per level. In some other embodiments, multiple component colors may be outputted by the same waveguide, such that, e.g., only a single waveguide may be provided per depth plane.

With continued reference to FIG. 8, in some embodiments, G is the color green, R is the color red, and B is the color blue. In some other embodiments, other colors associated with other wavelengths of light, including magenta and cyan, may be used in addition to or may replace one or more of red, green, or blue.

It will be appreciated that references to a given color of light throughout this disclosure will be understood to encompass light of one or more wavelengths within a range of wavelengths of light that are perceived by a viewer as being of that given color. For example, red light may include light of one or more wavelengths in the range of about 620-780 nm, green light may include light of one or more wavelengths in the range of about 492-577 nm, and blue light may include light of one or more wavelengths in the range of about 435-493 nm.

In some embodiments, the light source 530 (FIG. 6) may be configured to emit light of one or more wavelengths outside the visual perception range of the viewer, for example, infrared and/or ultraviolet wavelengths. In addition, the in-coupling, out-coupling, and other light redirecting structures of the waveguides of the display 250 may be configured to direct and emit this light out of the display towards the user's eye 210, e.g., for imaging and/or user stimulation applications.

With reference now to FIG. 9A, in some embodiments, light impinging on a waveguide may need to be redirected to in-couple that light into the waveguide. An in-coupling optical element may be used to redirect and in-couple the light into its corresponding waveguide. FIG. 9A illustrates a cross-sectional side view of an example of a plurality or set 660 of stacked waveguides that each includes an in-coupling optical element. The waveguides may each be configured to output light of one or more different wavelengths, or one or more different ranges of wavelengths. It will be appreciated that the stack 660 may correspond to the stacked waveguide assembly 260 (FIG. 6) and the illustrated waveguides of the stack 660 may correspond to part of the plurality of waveguides 270, 280, 290, 300, 310, except that light from one or more of the image injection devices 360, 370, 380, 390, 400 is injected into the waveguides from a position that requires light to be redirected for in-coupling.

The illustrated set 660 of stacked waveguides includes waveguides 670, 680, and 690. Each waveguide includes an associated in-coupling optical element (which may also be referred to as a light input area on the waveguide), with, e.g., in-coupling optical element 700 disposed on a major surface (e.g., an upper major surface) of waveguide 670, in-coupling optical element 710 disposed on a major surface (e.g., an upper major surface) of waveguide 680, and in-coupling optical element 720 disposed on a major surface (e.g., an upper major surface) of waveguide 690. In some embodiments, one or more of the in-coupling optical elements 700, 710, 720 may be disposed on the bottom major surface of the respective waveguide 670, 680, 690 (particularly where the one or more in-coupling optical elements are reflective, deflecting optical elements). As illustrated, the in-coupling optical elements 700, 710, 720 may be disposed on the upper major surface of their respective waveguide 670, 680, 690 (or the top of the next lower waveguide), particularly where those in-coupling optical elements are transmissive, deflecting optical elements. In some embodiments, the in-coupling optical elements 700, 710, 720 may be disposed in the body of the respective waveguide 670, 680, 690. In some embodiments, as discussed herein, the in-coupling optical elements 700, 710, 720 are wavelength selective, such that they selectively redirect one or more wavelengths of light, while transmitting other wavelengths of light. While illustrated on one side or corner of their respective waveguide 670, 680, 690, it will be appreciated that the in-coupling optical elements 700, 710, 720 may be disposed in other areas of their respective waveguide 670, 680, 690 in some embodiments.

As illustrated, the in-coupling optical elements 700, 710, 720 may be laterally offset from one another. In some embodiments, each in-coupling optical element may be offset such that it receives light without that light passing through another in-coupling optical element. For example, each in-coupling optical element 700, 710, 720 may be configured to receive light from a different image injection device 360, 370, 380, 390, and 400 as shown in FIG. 6, and may be separated (e.g., laterally spaced apart) from other in-coupling optical elements 700, 710, 720 such that it substantially does not receive light from the other ones of the in-coupling optical elements 700, 710, 720.

Each waveguide also includes associated light distributing elements, with, e.g., light distributing elements 730 disposed on a major surface (e.g., a top major surface) of waveguide 670, light distributing elements 740 disposed on a major surface (e.g., a top major surface) of waveguide 680, and light distributing elements 750 disposed on a major surface (e.g., a top major surface) of waveguide 690. In some other embodiments, the light distributing elements 730, 740, 750, may be disposed on a bottom major surface of associated waveguides 670, 680, 690, respectively. In some other embodiments, the light distributing elements 730, 740, 750, may be disposed on both top and bottom major surface of associated waveguides 670, 680, 690, respectively; or the light distributing elements 730, 740, 750, may be disposed on different ones of the top and bottom major surfaces in different associated waveguides 670, 680, 690, respectively.

The waveguides 670, 680, 690 may be spaced apart and separated by, e.g., gas, liquid, and/or solid layers of material. For example, as illustrated, layer 760a may separate waveguides 670 and 680; and layer 760b may separate waveguides 680 and 690. In some embodiments, the layers 760a and 760b are formed of low refractive index materials (that is, materials having a lower refractive index than the material forming the immediately adjacent one of waveguides 670, 680, 690). Preferably, the refractive index of the material forming the layers 760a, 760b is 0.05 or more, or 0.10 or less than the refractive index of the material forming the waveguides 670, 680, 690. Advantageously, the lower refractive index layers 760a, 760b may function as cladding layers that facilitate total internal reflection (TIR) of light through the waveguides 670, 680, 690 (e.g., TIR between the top and bottom major surfaces of each waveguide). In some embodiments, the layers 760a, 760b are formed of air. While not illustrated, it will be appreciated that the top and bottom of the illustrated set 660 of waveguides may include immediately neighboring cladding layers.

Preferably, for ease of manufacturing and other considerations, the material forming the waveguides 670, 680, 690 are similar or the same, and the material forming the layers 760a, 760b are similar or the same. In some embodiments, the material forming the waveguides 670, 680, 690 may be different between one or more waveguides, and/or the material forming the layers 760a, 760b may be different, while still holding to the various refractive index relationships noted above.

With continued reference to FIG. 9A, light rays 770, 780, 790 are incident on the set 660 of waveguides. It will be appreciated that the light rays 770, 780, 790 may be injected into the waveguides 670, 680, 690 by one or more image injection devices 360, 370, 380, 390, 400 (FIG. 6).

In some embodiments, the light rays 770, 780, 790 have different properties, e.g., different wavelengths or different ranges of wavelengths, which may correspond to different colors. The in-coupling optical elements 700, 710, 720 each deflect the incident light such that the light propagates through a respective one of the waveguides 670, 680, 690 by TIR. In some embodiments, the incoupling optical elements 700, 710, 720 each selectively deflect one or more particular wavelengths of light, while transmitting other wavelengths to an underlying waveguide and associated incoupling optical element.

For example, in-coupling optical element 700 may be configured to deflect ray 770, which has a first wavelength or range of wavelengths, while transmitting rays 780 and 790, which have different second and third wavelengths or ranges of wavelengths, respectively. The transmitted ray 780 impinges on and is deflected by the in-coupling optical element 710, which is configured to deflect light of a second wavelength or range of wavelengths. The ray 790 is deflected by the in-coupling optical element 720, which is configured to selectively deflect light of third wavelength or range of wavelengths.

With continued reference to FIG. 9A, the deflected light rays 770, 780, 790 are deflected so that they propagate through a corresponding waveguide 670, 680, 690; that is, the in-coupling optical elements 700, 710, 720 of each waveguide deflects light into that corresponding waveguide 670, 680, 690 to in-couple light into that corresponding waveguide. The light rays 770, 780, 790 are deflected at angles that cause the light to propagate through the respective waveguide 670, 680, 690 by TIR. The light rays 770, 780, 790 propagate through the respective waveguide 670, 680, 690 by TIR until impinging on the waveguide's corresponding light distributing elements 730, 740, 750.

With reference now to FIG. 9B, a perspective view of an example of the plurality of stacked waveguides of FIG. 9A is illustrated. As noted above, the in-coupled light rays 770, 780, 790, are deflected by the in-coupling optical elements 700, 710, 720, respectively, and then propagate by TIR within the waveguides 670, 680, 690, respectively. The light rays 770, 780, 790 then impinge on the light distributing elements 730, 740, 750, respectively. The light distributing elements 730, 740, 750 deflect the light rays 770, 780, 790 so that they propagate towards the out-coupling optical elements 800, 810, 820, respectively.

In some embodiments, the light distributing elements 730, 740, 750 are orthogonal pupil expanders (OPE's). In some embodiments, the OPE's deflect or distribute light to the out-coupling optical elements 800, 810, 820 and, in some embodiments, may also increase the beam or spot size of this light as it propagates to the out-coupling optical elements. In some embodiments, the light distributing elements 730, 740, 750 may be omitted and the in-coupling optical elements 700, 710, 720 may be configured to deflect light directly to the out-coupling optical elements 800, 810, 820. For example, with reference to FIG. 9A, the light distributing elements 730, 740, 750 may be replaced with out-coupling optical elements 800, 810, 820, respectively. In some embodiments, the out-coupling optical elements 800, 810, 820 are exit pupils (EP's) or exit pupil expanders (EPE's) that direct light in a viewer's eye 210 (FIG. 7). It will be appreciated that the OPE's may be configured to increase the dimensions of the eye box in at least one axis and the EPE's may be to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EP again, at which time another portion of the impinging light is directed out of the waveguide, and so on. Consequently, a single beam of incoupled light may be “replicated” each time a portion of that light is redirected by an OPE or EPE, thereby forming a field of cloned beams of light, as shown in FIG. 6. In some embodiments, the OPE and/or EPE may be configured to modify a size of the beams of light.

Accordingly, with reference to FIGS. 9A and 9B, in some embodiments, the set 660 of waveguides includes waveguides 670, 680, 690; in-coupling optical elements 700, 710, 720; light distributing elements (e.g., OPE's) 730, 740, 750; and out-coupling optical elements (e.g., EP's) 800, 810, 820 for each component color. The waveguides 670, 680, 690 may be stacked with an air gap/cladding layer between each one. The in-coupling optical elements 700, 710, 720 redirect or deflect incident light (with different in-coupling optical elements receiving light of different wavelengths) into its waveguide. The light then propagates at an angle which will result in TIR within the respective waveguide 670, 680, 690. In the example shown, light ray 770 (e.g., blue light) is deflected by the first in-coupling optical element 700, and then continues to bounce down the waveguide, interacting with the light distributing element (e.g., OPE's) 730 and then the out-coupling optical element (e.g., EPs) 800, in a manner described earlier. The light rays 780 and 790 (e.g., green and red light, respectively) will pass through the waveguide 670, with light ray 780 impinging on and being deflected by in-coupling optical element 710. The light ray 780 then bounces down the waveguide 680 via TIR, proceeding on to its light distributing element (e.g., OPEs) 740 and then the out-coupling optical element (e.g., EP's) 810. Finally, light ray 790 (e.g., red light) passes through the waveguide 690 to impinge on the light in-coupling optical elements 720 of the waveguide 690. The light in-coupling optical elements 720 deflect the light ray 790 such that the light ray propagates to light distributing element (e.g., OPEs) 750 by TIR, and then to the out-coupling optical element (e.g., EPs) 820 by TIR. The coupling optical element 820 then finally out-couples the light ray 790 to the viewer, who also receives the out-coupled light from the other waveguides 670, 680.

FIG. 9C illustrates a top-down plan view of an example of the plurality of stacked waveguides of FIGS. 9A and 9B. As illustrated, the waveguides 670, 680, 690, along with each waveguide's associated light distributing element 730, 740, 750 and associated out-coupling optical element 800, 810, 820, may be vertically aligned. However, as discussed herein, the in-coupling optical elements 700, 710, 720 are not vertically aligned; rather, the in-coupling optical elements are preferably non-overlapping (e.g., laterally spaced apart as seen in the top-down view). As discussed further herein, this nonoverlapping spatial arrangement facilitates the injection of light from different resources into different waveguides on a one-to-one basis, thereby allowing a specific light source to be uniquely coupled to a specific waveguide. In some embodiments, arrangements including nonoverlapping spatially-separated in-coupling optical elements may be referred to as a shifted pupil system, and the in-coupling optical elements within these arrangements may correspond to sub pupils.

FIG. 9D illustrates an example of wearable display system 60 into which the various waveguides and related systems disclosed herein may be integrated. In some embodiments, the display system 60 is the system 250 of FIG. 6, with FIG. 6 schematically showing some parts of that system 60 in greater detail. For example, the waveguide assembly 260 of FIG. 6 may be part of the display 70.

With continued reference to FIG. 9D, the display system 60 includes a display 70, and various mechanical and electronic modules and systems to support the functioning of that display 70. The display 70 may be coupled to a frame 80, which is wearable by a display system user or viewer 90 and which is configured to position the display 70 in front of the eyes of the user 90. The display 70 may be considered eyewear in some embodiments. In some embodiments, a speaker 100 is coupled to the frame 80 and configured to be positioned adjacent the ear canal of the user 90 (in some embodiments, another speaker, not shown, may optionally be positioned adjacent the other ear canal of the user to provide stereo/shapeable sound control). The display system 60 may also include one or more microphones 110 or other devices to detect sound. In some embodiments, the microphone is configured to allow the user to provide inputs or commands to the system 60 (e.g., the selection of voice menu commands, natural language questions, etc.), and/or may allow audio communication with other persons (e.g., with other users of similar display systems. The microphone may further be configured as a peripheral sensor to collect audio data (e.g., sounds from the user and/or environment). In some embodiments, the display system may also include a peripheral sensor 120a, which may be separate from the frame 80 and attached to the body of the user 90 (e.g., on the head, torso, an extremity, etc. of the user 90). The peripheral sensor 120a may be configured to acquire data characterizing a physiological state of the user 90 in some embodiments. For example, the sensor 120a may be an electrode.

With continued reference to FIG. 9D, the display 70 is operatively coupled by communications link 130, such as by a wired lead or wireless connectivity, to a local data processing module 140 which may be mounted in a variety of configurations, such as fixedly attached to the frame 80, fixedly attached to a helmet or hat worn by the user, embedded in headphones, or otherwise removably attached to the user 90 (e.g., in a backpack-style configuration, in a belt-coupling style configuration). Similarly, the sensor 120a may be operatively coupled by communications link 120b, e.g., a wired lead or wireless connectivity, to the local processor and data module 140. The local processing and data module 140 may include a hardware processor, as well as digital memory, such as non-volatile memory (e.g., flash memory or hard disk drives), both of which may be utilized to assist in the processing, caching, and storage of data. Optionally, the local processor and data module 140 may include one or more central processing units (CPUs), graphics processing units (GPUs), dedicated processing hardware, and so on. The data may include data a) captured from sensors (which may be, e.g., operatively coupled to the frame 80 or otherwise attached to the user 90), such as image capture devices (such as cameras), microphones, inertial measurement units, accelerometers, compasses, GPS units, radio devices, gyros, and/or other sensors disclosed herein; and/or b) acquired and/or processed using remote processing module 150 and/or remote data repository 160 (including data relating to virtual content), possibly for passage to the display 70 after such processing or retrieval. The local processing and data module 140 may be operatively coupled by communication links 170, 180, such as via a wired or wireless communication links, to the remote processing module 150 and remote data repository 160 such that these remote modules 150, 160 are operatively coupled to each other and available as resources to the local processing and data module 140. In some embodiments, the local processing and data module 140 may include one or more of the image capture devices, microphones, inertial measurement units, accelerometers, compasses, GPS units, radio devices, and/or gyros. In some other embodiments, one or more of these sensors may be attached to the frame 80, or may be standalone structures that communicate with the local processing and data module 140 by wired or wireless communication pathways.

With continued reference to FIG. 9D, in some embodiments, the remote processing module 150 may include one or more processors configured to analyze and process data and/or image information, for instance including one or more central processing units (CPUs), graphics processing units (GPUs), dedicated processing hardware, and so on. In some embodiments, the remote data repository 160 may include a digital data storage facility, which may be available through the internet or other networking configuration in a “cloud” resource configuration. In some embodiments, the remote data repository 160 may include one or more remote servers, which provide information, e.g., information for generating augmented reality content, to the local processing and data module 140 and/or the remote processing module 150. In some embodiments, all data is stored and all computations are performed in the local processing and data module, allowing fully autonomous use from a remote module. Optionally, an outside system (e.g., a system of one or more processors, one or more computers) that includes CPUs, GPUs, and so on, may perform at least a portion of processing (e.g., generating image information, processing data) and provide information to, and receive information from, modules 140, 150, 160, for instance via wireless or wired connections.

### Waveguides Integrated With Optical Elements Including Slanted Gratings

Providing an immersive experience to a user of waveguide-based display systems, e.g., various semitransparent or transparent display systems configured for virtual/augmented/mixed reality display applications described supra, depends on, among other things, various characteristics of the light coupling into and out of the waveguides of the display systems. For example, a virtual/augmented/mixed reality display having high light incoupling and outcoupling efficiencies for one or more polarizations of light can enhance the viewing experience by providing relatively high brightness and/or clarity.

As described supra, e.g., in reference to FIGS. 6 and 7, display systems according to various embodiments described herein may include optical elements, e.g., in-coupling optical elements, out-coupling optical elements, and light distributing elements, which may in turn include diffraction gratings or diffractive optical elements (DOEs). The in-coupling optical elements such as in-coupling diffraction gratings (ICGs) (which can be slanted gratings as described herein) may be employed to couple light into the waveguides, and out-coupling optical elements such as exit pupil expanders (EPEs) may be employed to couple light out of the waveguides into the user's eyes. For example, as described above in reference to FIGS. 6 and 7, light 640 that is injected into the waveguide 270 at the input surface 460 of the waveguide 270 propagates within the waveguide 270 by total internal reflection (TIR). At points where the light 640 impinges on the out-coupling optical element 570, a portion of the light exits the waveguide as beamlets 650. In some embodiments, any of the optical elements 570, 580, 590, 600, 610 can include or be configured as a diffraction grating or DOE.

To achieve desirable characteristics of in-coupling of light into (or out-coupling of light from) the waveguides 270, 280, 290, 300, 310, the optical elements 570, 580, 590, 600, 610 configured as diffraction gratings or DOEs can be formed of a suitable material and have a suitable structure for controlling various optical properties, including diffraction properties. The desirable diffraction properties include, among other properties, spectral selectivity, angular selectivity, polarization selectivity, high spectral bandwidth, a wide field of view and high diffraction efficiencies.

To achieve one or more of these and other advantages including relatively high diffraction efficiencies of the optical elements, various example optical elements described herein include a slanted grating (sometimes referred to as a “slanted diffraction grating”). A slanted grating refers to a grating having an array of surface-relief trenches, where sidewalls of the trenches, in a tiling direction of the array, have a substantially uniform non-normal slant angle in reference to a surface in which the trenches are formed, such as a substrate surface. The slant angle partially determines an intensity of light diffracted by the slanted grating. A slanted grating can be distinguished from a blazed grating (in which sidewalls of the surface relief features in the tiling direction of the feature array are non-parallel with one another) and a binary grating (in which sidewalls of the surface relief features in the tiling direction of the feature array are normal to the surface in which the features are formed). Compared to binary gratings, slanted gratings can provide higher diffraction efficiency (e.g., for a particular order, such as 1^{st} order diffraction), e.g., so as to guide output light in a desired direction more efficiently and/or so as to guide input light into a waveguide more efficiently.

Slanted gratings are often (though not always) utilized in a transmission mode. For example, a slanted grating can be disposed above a waveguide. Light incident on the slanted grating passes through the slanted grating and is diffracted into the waveguide. Compared to blazed gratings, slanted gratings can diffract light with less dependence on the light's polarization.

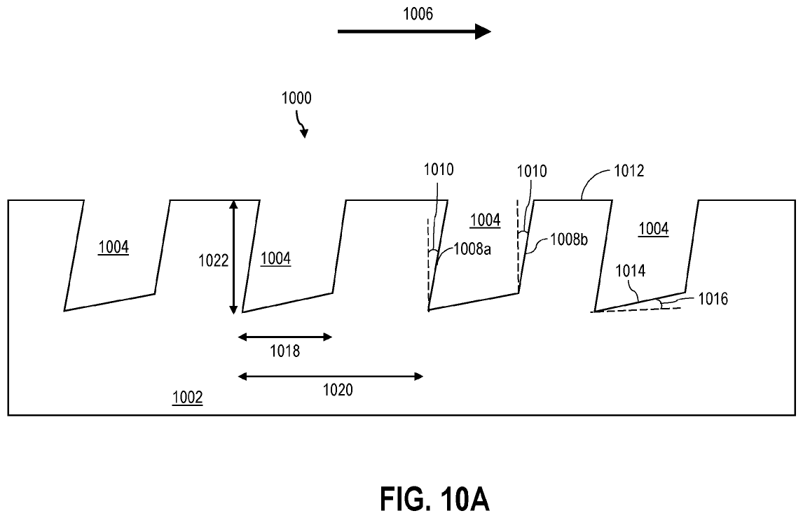

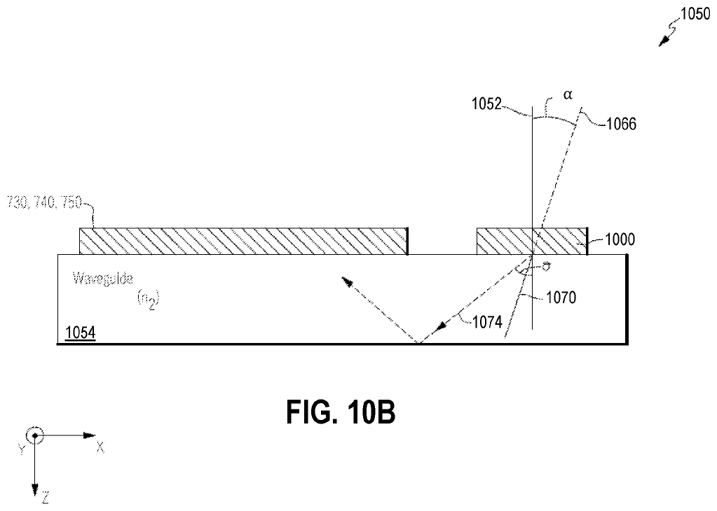

FIG. 10A is a cross-sectional view of an example of a slanted grating 1000 formed in a substrate 1002. The slanted grating 1000 can be included as part of an optical element, such as an in-coupling optical element and/or an out-coupling optical element or both, and/or the slanted grating 1000 can be used as a master template for fabrication of other slanted gratings. The slanted grating 1000 includes trenches 1004 (e.g., periodically repeating trenches) tiled in an array direction 1006. Each trench 1004 (sometimes referred to herein as a “second trench” formed by etching a “first trench”) is defined partially by sidewalls in the array direction 1006 (such as sidewalls 1008a, 1008b) that are substantially parallel to one another. The sidewalls 1008a, 1008b have a slant angle 1010 with respect to a normal to a surface 1012 of the substrate 1002. A base 1014 of each trench 1004 has a tilt angle 1016 with respect to the surface 1012. The tilt angle 1016 can be 0° (e.g., flat-bottomed trenches) or non-zero, in various embodiments.

Besides the slant angle 1010 and the tilt angle 1016, the slanted grating 1000 can be defined by a width 1018 of each trench 1004; a pitch 1020 defining an inter-trench spacing; and a height (depth) 1022 of each trench 1004. The height 1022, as defined herein, refers to a distance between a deepest point of each trench 1004 and the surface 1012 in which the trenches 1004 are defined.

In some embodiments, the width 1018 and the pitch 1020 are uniform for the entire slanted grating 1000, such that the slanted grating 1000 includes a periodic array of identical trenches 1004 having identical pitches 1020. However, in some embodiments, one or both of these parameters differs between trenches 1004. For example, as non-limiting examples, the trenches 1004 can alternate between wider and thinner trenches (larger and smaller width 1018) and/or alternate being closer together and farther apart (larger and smaller pitch 1020). As further examples, one or both of the width 1018 or the pitch 1020 can gradually increase or decrease in the direction 1006 of the array of trenches 1004. The width 1018 and the pitch 1020 of a master template can be determined by the geometry of lithographic mask features formed during fabrication of the slanted grating 1000.

In some embodiments, the width 1018 is between 50 nm and 1 μm, e.g., between 100 nm and 500 nm. In some embodiments, the pitch 1020 is between 50 nm and 2 μm. In some embodiments, the height 1022 is between 50 nm and 1 μm, such as between 50 nm and 400 nm. The dimensions can be based on, for example, wavelength(s) of light that the slanted grating is configured to diffract.

The width 1018 extends between two sidewalls 1008 of each trench 1004 (e.g., parallel sidewalls 1008 defined by a crystal plane). The trenches 1004 have lengths that are longer than the width 1018, e.g., lengths that extend longitudinally orthogonally to the array direction 1006, e.g., in/out of the plane of the cross-section of FIG. 10A. For example, the length can be at least 10×, at least 100×, or at least 1000× the width 1018.

Slanted gratings can be fabricated by imprinting a slanted grating pattern into a replication material on a device substrate, e.g., a device substrate that is or includes a waveguide, using a master template (itself a slanted grating) as an imprint mold. For example, the master template can be a slanted grating pattern in a “hard” material, such as a semiconductor, an oxide, or a nitride, while the replication material can be a “soft” material such as a polymer, e.g., a thermoplastic polymer. Accordingly, a quality of a slanted grating on a device substrate (as determined by topological features of the slanted grating) is dependent on a quality of a corresponding slanting grating of the master template.

The master template of a slanted grating can be fabricated using ion milling in order to form the trenches of the grating. For example, a mask layer having periodically-repeating openings can be formed on a semiconductor substrate, and the substrate can be etched through the openings using an ion beam (e.g., a fluoride-based ion beam) incident on the substrate at a non-normal angle. However, the trenches formed in this process often have tapered (non-parallel) sidewalls and/or sidewalls that are otherwise non-uniform or poorly-defined, e.g., including bumps/depressions in the sidewalls, high sidewall roughness, etc. This may result in slanted gratings having poor optical performance, such as lower diffraction efficiency and/or more scattered light, compared to slanted gratings that have more uniform profiles.

Embodiments according to this disclosure include methods for forming slanted gratings using etch processes having crystallographic plane selectivity. The trenches of the slanted gratings formed by these methods are defined by crystallographic planes and are, accordingly, highly smooth and uniform, within and between trenches. The resulting slanted gratings may provide improved optical performance (e.g., higher diffraction efficiency, more efficient light in-coupling, and/or more efficient light out-coupling) than less-uniform slanted gratings formed by alternative methods. Moreover, in some embodiments, these methods replace time-consuming and expensive ion milling processes with comparatively faster and lower-cost wet chemical etches, improving overall process efficiency.

FIG. 10B illustrates a cross-sectional view of a portion of a display device 1050 including a waveguide 1054 and the slanted grating 1000 formed on the waveguide 1054 according to some embodiments. The slanted grating 1000 is configured to diffract light having a wavelength in the visible spectrum such that the light is guided within the waveguide 1054 by TIR. The waveguide 1054 can correspond to one of waveguides 670, 680, 690 described above with respect to FIGS. 9A-9C, for example. As described above, the slanted grating 1000 can correspond to, e.g., an in-coupling optical element (700, 710, 720, FIGS. 9A-9C), also referred to herein as an in-coupling grating (ICG).

The display device 1050 can additionally include various other optical elements as part of a display device described above, including out-coupling optical elements. For example, in the illustrated embodiment, the display device 1050 additionally includes light distributing elements 730, 740, 750 similar to those described above with respect to FIGS. 9A-9C. The display device 1050 can include other elements including out-coupling optical elements (800, 810, 820, FIGS. 9A-9C), for example.

In operation, when an incident light beam 1066, e.g., visible light, is incident on the slanted grating 1000 at an angle of incidence a measured relative to a plane normal 1052 that is normal or orthogonal to a surface extending in the y-x plane (e.g., a plane of the surface 1012), the slanted grating 1000 at least partially diffracts the incident light beam 1066 as a diffracted light beam 1074 at a diffraction angle θ measured relative to the plane normal 1052, while at least partially transmitting the incident light as a transmitted light beam 1070. When the diffracted light beam 1024 is diffracted at a diffraction angle θ that exceeds a critical angle θ_TIR for occurrence of total internal reflection in the waveguide 1054, the diffracted light beam 1074 is guided within the waveguide 1054 along the x-axis via total internal reflection (TIR) until the diffracted light beam 1074 reaches one of light distributing elements 730, 740, 750, for example, or one of the out-coupling optical elements (800, 810, 820, FIGS. 9A-9C), for example.

### Fabrication of Slanted Gratings

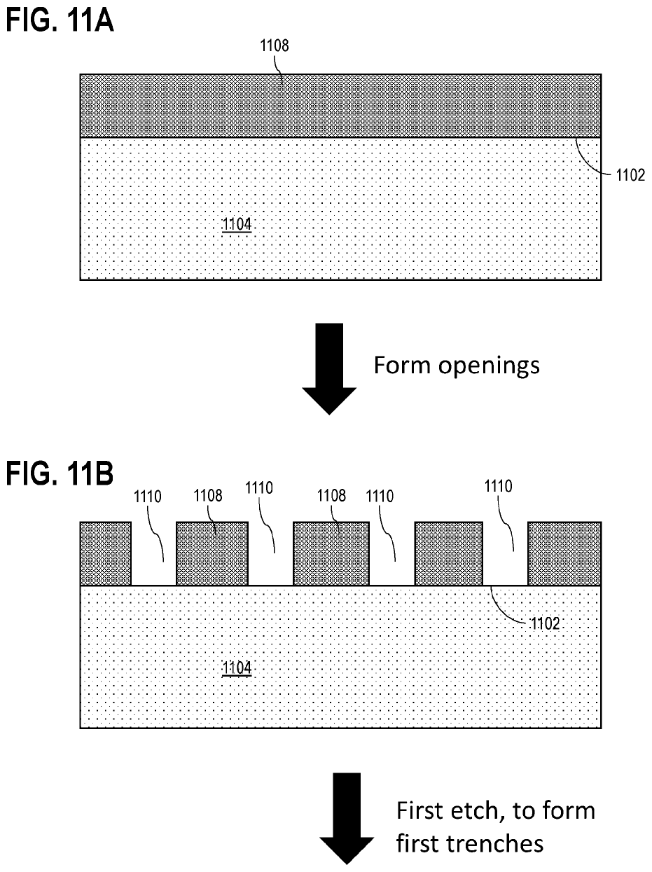

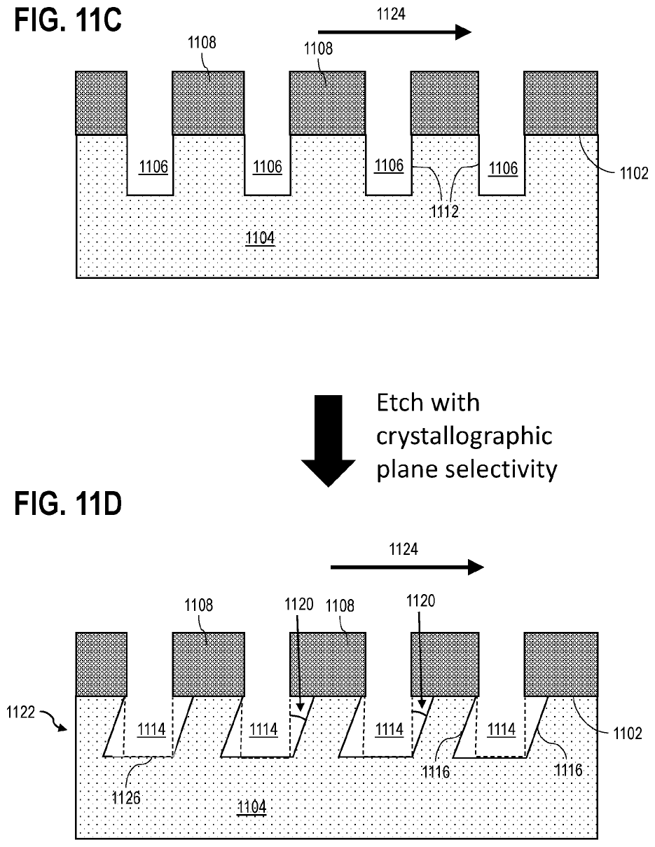

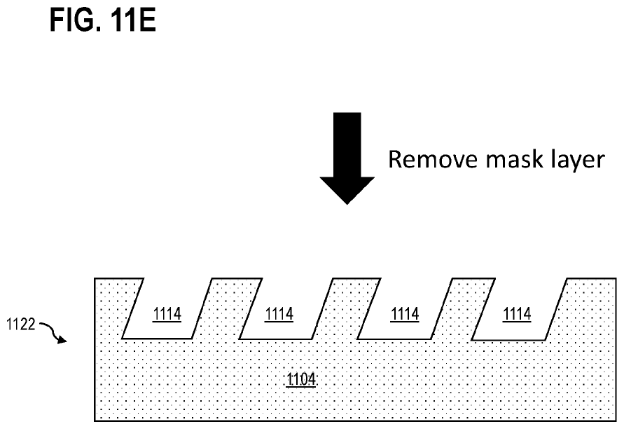

FIGS. 11A-11E illustrate an example of a process for fabricating a slanted grating. As shown in FIGS. 11A-11C, an array of first trenches 1106 (e.g., periodically-repeating trenches) are patterned in a surface 1102 of a substrate 1104. The substrate 1104 is a crystalline substrate having a defined, regular crystal structure. For example, in some embodiments the substrate 1104 is a silicon substrate, a germanium substrate, a crystalline aluminum oxide substrate, or another substrate having a defined, regular crystal structure that is etchable with crystallographic plane selectivity. The crystal structure, in combination with the crystallographically-selective etch, will facilitate the fabrication of slanted gratings, as described below.

In some embodiments (e.g., in the embodiment of FIGS. 11A-11E), the first trenches 1106 are patterned using a mask-based lithography process. As shown in FIG. 11A, a mask layer 1108 is formed/provided on the substrate 1104. The mask layer 1108 is composed of one or more materials that are selectively resistant to etching, compared to the substrate 1104, by (i) the first etch process to form the array of first trenches 1106 and (ii) the second etch process to etch surfaces of the first trenches 1106 to form a slanted grating. For example, in some embodiments the mask layer 1108 is an oxide (e.g., silicon oxide (such as silicon dioxide)), a nitride (e.g., silicon nitride), a metal, a semiconductor, or an organic material (e.g., a photoresist or a polymer). The mask layer 1108 can be formed by one or more fabrication processes, such as thermal evaporation, electron-beam evaporation, sputtering, chemical vapor deposition (CVD), atomic layer deposition (ALD), spin-deposition, and/or film growing (e.g., oxidation of a silicon substrate 1104 to obtain a silicon dioxide mask layer 1108), any of which can be combined with thermal anneal(s) and/or other processes to form the mask layer 1108.

As shown in FIG. 11B, openings 1110 are formed in the mask layer 1108, exposing the underlying surface 1102. For example, the openings 1110 can be formed by a photolithography and/or electron-beam lithography process. In some embodiments, the mask layer 1108 is composed of a hard mask material (e.g., an oxide or a nitride), and the openings 1110 are formed by depositing a photoresist or electron-beam resist layer on the mask layer 1108, patterning first openings in the resist layer by lithography, and etching the mask layer 1108 through the first openings to form the openings 1110.

As shown in FIG. 11C, in some embodiments, the substrate 1104 is etched in a first etch through the openings 1110, forming the first trenches 1106 that are tiled in (e.g., periodically repeat in) an array direction 1124. The first etch is selective to the substrate 1104 compared to the mask layer 1108. In some embodiments, the substrate 1104 is a silicon substrate, and the first etch includes a dry etch such as a plasma etch, e.g., a chlorine-based plasma etch and/or a bromine-based plasma etch and/or a fluorine-based plasma etch. When the mask layer 1108 is silicon dioxide or silicon nitride, these and/or other plasma etches can be highly selective to the silicon substrate 1104 compared to the mask layer 1108. In some embodiments, the first etch includes another type of etch, such as a chemical etch using an etching solution. In some embodiments, the first etch is a vertically-anisotropic etch, such that the first trenches 1106 have substantially vertical sidewalls 1112 aligned with edges of the mask layer 1108.

The first trenches 1106 can be patterned by other processes besides the example process of FIGS. 11A-11C. For example, in some embodiments the first trenches 1106 are patterned by direct ion milling of the substrate 1104 (e.g., without using a mask layer 1108), or by a maskless stop-layer method.

In some embodiments, the patterning of the first trenches 1106, based on which a slanted grating is fabricated as described below, allows dimensions of the slanted grating to be set based on precise and reliable lithographic methods. For example, distance(s) between the centers of the first trenches 1106 are equal to pitch(es) 1020 of the slanted grating. Depth(s) of the first trenches 1106 can be approximately equal to height(s) 1022 of trenches of the slanted grating. Whether the height 1022 is different from the depth of the first trenches 1106 depends at least on the crystal orientation of the substrate 1104.

For example, when bases of the first trenches 1106 are defined by slow-etching crystal planes (e.g., when the bases are defined by a (1 1 1) plane of a diamond cubic crystal structure, such as when the bases are parallel to the surface 1102 in a (1 1 1)-oriented substrate 1104), the bases will be etched slowly or not at all by the subsequent crystallographically-selective etch, and the height 1022 is equal to the depth of the first trenches 1106. When the bases are not defined by slow planes, the height 1022 may be altered by the etch. The width 1018 of the slanted grating increases compared to the width of the first trenches 1106. For example, for a (1 1 1)-oriented substrate 1104, the width 1018 increases by an amount (height 1022)·tan(19.5°) compared to the width of the first trenches 1106, and, in some embodiments, the width 1018 increases by approximately (height 1022)·tan(θ), where θ is the slant angle of the fabricated slanted grating. Accordingly, the width of the first trenches 1106 can be determined based on the known increase to obtain a target width 1018 of the slanted grating.

Dimensions of the first trenches 1106 can be provided by precise lithography to define the openings 1110 in the mask layer 1108, followed by precise etching (at a well-controlled etch rate, e.g., using plasma etching) to form the first trenches 1106 in the openings 1110. This precise control over dimensions of the first trenches 1106 is then translated to the dimensions of the trenches of the slanted grating, such that the dimensions are of the slanted grating are also precisely controllable. Accordingly, the slanted grating can be provided with dimensions that facilitate desired optical characteristics.

As shown in FIG. 11D, in a second etch process, surfaces of the first trenches 1106 are etched using an etchant with crystallographic plane selectivity, to pattern second trenches 1114 that together form a slanted grating 1122. The etchant has crystallographic plane selectivity in that the etchant etches a first crystal plane of the substrate 1104 faster than a second crystal plane of the substrate 1104. The second trenches 1114 are tiled in (e.g., periodically repeat in) the array direction 1124. The second etch etches towards some crystallographic plane(s) (“fast” planes) of the substrate 1104 faster than towards other crystallographic plane(s) (“slow” planes). Appropriate selection of (i) the substrate 1104, (ii) an orientation of the substrate 1104 (e.g., crystallographic plane represented by the surface 1102, and (iii) the second etch can together result in the second trenches 1114 having slanted sidewalls with respect to the surface 1102. Specifically, if slow planes of the crystal structure of the substrate 1104 have slanted angles with respect to the surface 1102, the second etch can substantially terminate at those slow planes, such that sidewalls 1116 of the second trenches 1114 (as formed by the second etch's etching of surfaces of the first trenches 1106) are defined by the slow planes. The slant angle 1120 of the slanted grating 1122 matches the angle of the slow plane with respect to the crystal plane of the surface 1102. Because the slow planes of the crystal structure are parallel to one another, the sidewalls 1116 of the second trenches 1114 are also formed parallel to one another. In addition, in some embodiments, the sidewalls 1116 are smooth, based on the crystal planes'smoothness (e.g., sub-nm smoothness). Moreover, the precise and reliable -arrangement of planes within the crystal structure allows the slant angle 1120 to be determined and configured precisely based on knowledge of the crystal structure and corresponding selection of the substrate 1104.

Some embodiments according to this disclosure are based on materials having the diamond cubic crystal structure, such as silicon, germanium, silicon-germanium alloys, and diamond. When the substrate is composed of a single-crystal or near-single crystal of such a material, slow etching of {1 1 1} planes of the substrate allows the {1 1 1} planes to define the sidewalls of the second trenches, forming a slanted grating. Slow etching of {1 1 1} planes of diamond cubic crystal materials can be provided by various chemical etchant(s). For example, potassium hydroxide (KOH) solutions (e.g., between 10% and 50% KOH) etch {1 1 1} planes of silicon 10×-100× more slowly than other planes, such as {1 1 0} planes and {1 0 0} planes. The {1 1 1} planes are slow planes, and the {1 1 0} and {1 0 0} planes are fast planes. Tetramethylammonium hydroxide (TMAH) is another example of an etchant with crystallographic plane selectivity for silicon that can be used to form the trenches of the slanted grating with sidewalls defined by {1 1 1} planes. In an example of a chemical etch, the structure illustrated in FIG. 11C (e.g., with a silicon substrate 1104) is immersed in a 10%-20% solution of KOH held between 65° C. and 75° C. for between 10 and 30 second, e.g., 20 seconds. The etch rate of silicon under these conditions can be about 1 μm/minute for some planes, and slower for other planes, such as {1 1 1} planes. The etch with crystallographic plane selectivity is not limited to wet chemical etches. In some embodiments, a plasma etch with crystallographic plane selectivity is used. For example, for silicon, plasma etches in a gas of SF₆, C₄F₈, and O₂ exhibit selectively-slow etching of {1 1 1} planes. In some embodiments, a germanium substrate is etched using a hydrogen peroxide (H₂O₂)-based solution for which {1 1 1} planes are slow planes.

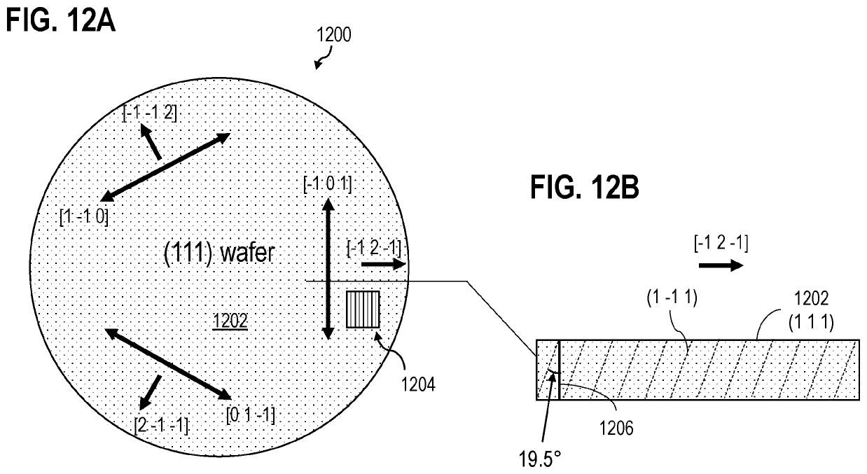

For example, the substrate can have a surface defined by a {1 1 1} plane of the diamond cubic crystal structure. As shown in FIG. 12A, a (1 1 1) substrate 1200 (often sourced in wafer form as a (1 1 1) wafer) has its surface 1202 orthogonal to the [1 1 1] direction of the diamond cubic crystal structure or, equivalently, the surface 1202 is defined by the (1 1 1) plane of the diamond cubic crystal structure. The {1 1 1} plane family includes, in addition to the (1 1 1) plane, the (−1 1 1) plane, the (1 −1 1) plane, and the (1 1 −1) plane. When the substrate 1200 is a (1 1 1) substrate or a substrate having another suitable orientation (e.g., as described in reference to FIGS. 12A-12B, 14A-14B, and 16A-16B), one or more of the (−1 1 1) plane, the (1 −1 1) plane, or the (1 1 −1) plane can be used, in conjunction with an etch for which the {1 1 1} planes are slow planes, to define slanted sidewalls of a slanted grating. Equivalently, the substrate 1200 can be referred to, for example, as a (−1 1 1) substrate, in which case the (1 1 1), (1 −1 1), and/or (1 1 −1) planes can define sidewalls of the slanted grating. This disclosure uses the convention of a (1 1 1) substrate and refers to particular examples of related crystal planes (e.g., the (1 −1 1) plane) as defining sidewalls, with the understanding that crystal symmetries allow the same fabrication processes to be described in terms of other, but equivalent, crystal planes/directions.

Referring again to FIG. 12A, using the (1 1 1) substrate 1200, slanted gratings can be formed having an array direction (e.g., direction 1006, 1124) in a <2 −1 −1> direction in the (1 1 1) plane, e.g., in the [2 −1 −1] direction, the [−1 −1 2] direction, and/or the [−1 2 −1] direction. The array direction is the direction toward which the sidewalls are angled. Trenches of the slanted gratings extend longitudinally along a perpendicular <1 1 0>direction in the (1 1 1) plane, e.g., in the [0 1 −1] direction, the [1 −1 0] direction, and/or the [−1 0 1] direction, respectively. These three pairs of directions correspond to the three other planes (besides (1 1 1)) in the {1 1 1} family of planes, e.g., the (−1 1 1) plane, the (1 1 −1) plane, and/or the (1 −1 1) plane, respectively, which define sidewalls for resulting slanted gratings.

For example, FIG. 12B illustrates a cross-section cut in the [−1 −2 −1] direction perpendicular to the [−1 0 −1] direction. A slanted grating 1204 can be formed with array direction in the [−1 2 −1] direction. In the cross-section, (1 −1 1) planes have an angle of approximately 19.5° with the normal direction 1206 to the (1 1 1) plane. Because the (1 −1 1) planes are slow planes that can substantially define sidewalls of resulting trenches, trenches of the slanted grating 1204 correspondingly have a slant angle of 19.5°.

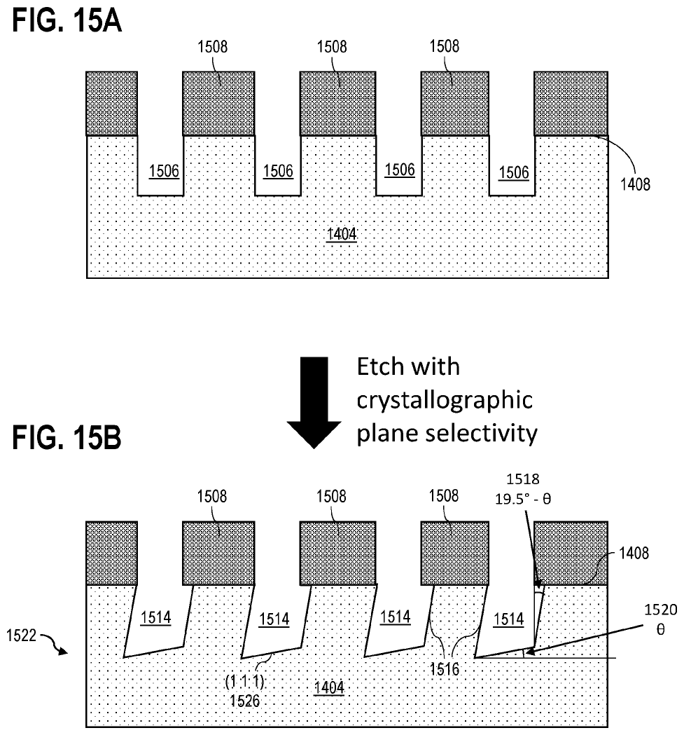

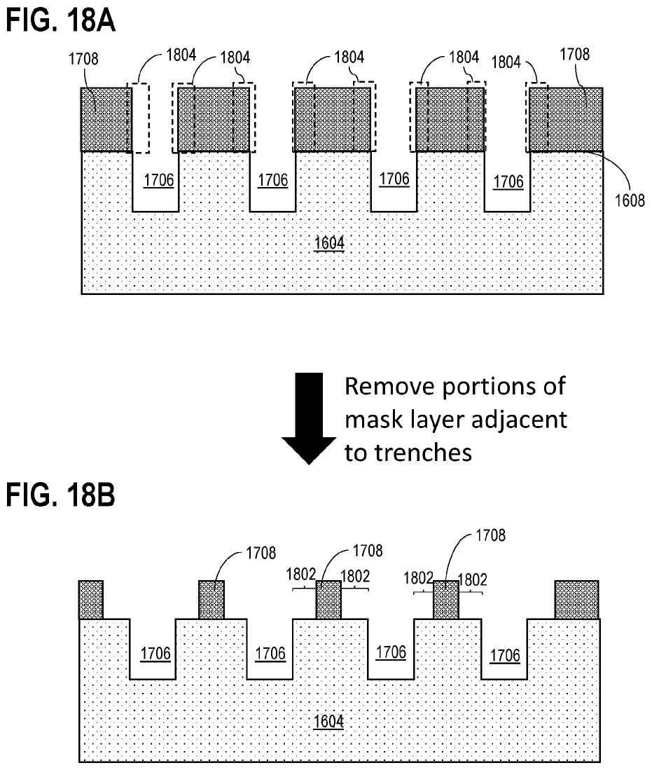

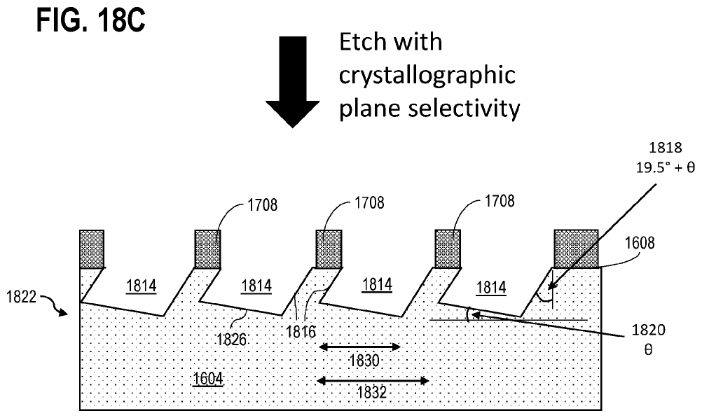

In reference to FIG. 11D, in the case where the slanted grating 1122 is the slanted grating 1204: the array direction 1124 is the [−1 2 −1] direction (more generally, a −2 −1 −1> direction); the surface 1102 is a (1 1 1) plane (more generally, a {1 1 1} plane); the sidewalls 1116 are (1 −1 1) planes (more generally, {1 1 1} planes; the slant angle 1120 is 19.5°; and the bases 1126 are (1 1 1) planes (more generally, {1 1 1} planes), parallel to the surface 1102. In this example, the bases 1126 are parallel to the surface 1102, e.g., because bases of the first trenches 1106 are also defined by (1 1 1) planes, such that the bases of the first trenches 1106 are etched evenly to maintain a constant (parallel) orientation with respect to the surface 1102. However, in some embodiments, the bases of trenches of slanted gratings are non-parallel with the surfaces in which the trenches are formed, e.g., as in the examples of FIGS. 15B and 18C.

As shown in FIG. 11E, subsequent to forming the second trenches 1114 of the slanted grating 1122, the mask layer 1108 (when present) can be removed, to obtain the slanted grating 1122 exposed as a surface relief structure in the substrate 1104. In some embodiments, the mask layer 1108 is removed using a wet chemical etch. For example, a silicon dioxide mask layer 1108 can be removed using a hydrofluoric acid (HF) etch.

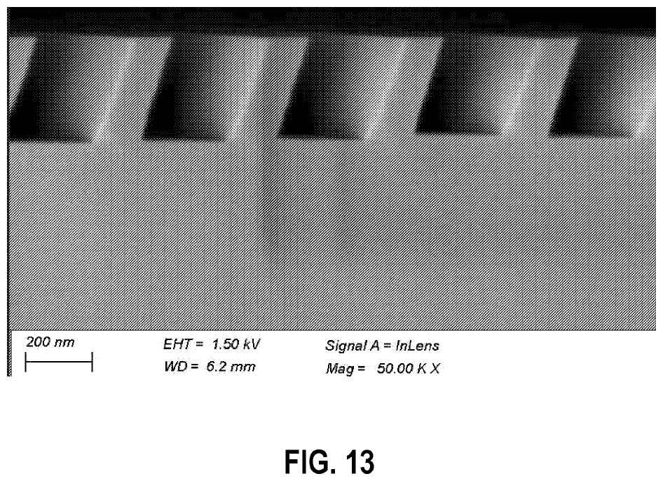

FIG. 13 is a scanning electron microscope (SEM) image of a slanted grating formed by periodically-repeating trenches in a silicon wafer, according to the process illustrated in FIGS. 11A-11E. The slanted grating was formed using a (1 1 1) silicon wafer, a silicon dioxide mask layer 1108, and a KOH etch with crystallographic plane selectivity. As is evident in the SEM image, sidewalls of the trenches are highly uniform and smooth, parallel to one another, and slanted (in this example, with respect to bases of the trenches, which are parallel to the (1 1 1) surface of the wafer in which the trenches were formed).

Because sidewalls of the trenches are defined by particular slow planes of the crystal structure of the substrate, and because, for a given substrate, the slow planes have a set, predetermined relationship with the surface of the substrate, the slant angle of the trenches (as defined in reference to a normal to the substrate surface) may be an unmodifiable parameter for a given substrate. For example, for (1 1 1) substrates where a {1 1 1} plane is the slow plane, the slant angle is approximately 19.5°. However, by appropriate selection of the substrate, arbitrary slant angles can be obtained.

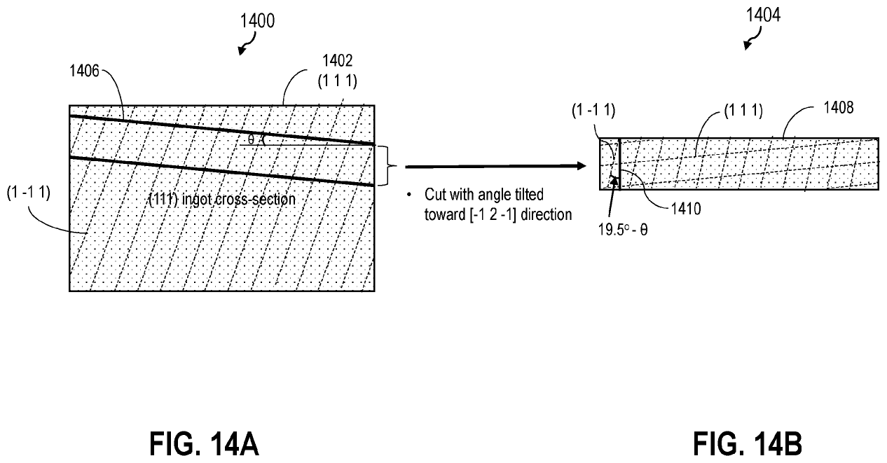

In embodiments in which slanted gratings are formed using {1 1 1} slow planes in diamond cubic crystal structures, slant angles different from 19.5° can be obtained by using a substrate having a surface that is sloped directly in a <2 −1 −1> direction with respect to a {1 1 1} plane. For example, the substrate can be obtained (or can be crystallographically equivalent to a substrate that is obtained) by slicing a {1 1 1}-oriented ingot with a cutting angle tilted toward a {2 −1 −1} direction. As shown in FIG. 14A, a (1 1 1)-oriented ingot 1400 has a (1 1 1) surface 1402. To form a (1 1 1) wafer, the ingot 1400 would be cut parallel to the surface 1402. To obtain a substrate 1404 (illustrated in FIG. 14B) configured for fabrication of slanted gratings with slant angles less than 19.5°, the ingot 1400 is sliced at a cutting angle θ with respect to the (1 1 1) plane, toward a {2 −1 −1} direction (in this example, the [−1 2 −1] direction). That is, the slicing plane 1406 along which the ingot 1400 is sliced is the (1 1 1) plane tilted downward in the [−1 2 −1] direction. The cutting angle θ is 0<θ<19.5°.

As a result of this slicing, substrate 1404 has a surface 1408 that is tilted at the cutting angle θ with respect to the (1 1 1) plane. Moreover, the normal direction 1410 to the surface 1408, rather than forming an angle 19.5° with the (1 −1 1) planes, forms an angle 19.5°−θ with the (1 −1 1) planes.

As shown in FIG. 15A, first trenches 1506 can be patterned in the substrate 1404, e.g., using a mask layer 1508 as described in reference to FIGS. 11A-11C. The first trenches 1506 are formed in the surface 1408 of the substrate 1404 (the surface 1408 having the angle θ with respect to the (1 1 1) plane). Elements of FIGS. 15A-15B can have characteristics as described for corresponding elements of FIGS. 11A-11E, except where noted otherwise.

As shown in FIG. 15B, the substrate 1404 is etched in an etch process for which the (1 −1 1) plane is a slow plane (e.g., an etch process as described in reference to FIG. 11D), such that second trenches 1514 are formed with sidewalls 1516 defined by (1 −1 1) planes. The second trenches 1514 form a slanted grating 1522. The second trenches 1514 have slant angles 1518 (defined as the sidewalls'angle with respect to a normal direction to the surface 1408) equal to 19.5°−θ. Accordingly, by appropriate selection of the substrate 1404 having a surface at the angle θ to the (1 1 1) plane, a slanted grating 1522 having a desired slant angle less than 19.5° can be fabricated in substrates with diamond cubic crystal structures, e.g., to configure a diffraction intensity of the slanted grating 1522 using a target slant angle less than 19.5°.

Bases 1526 of the second trenches 1514 are defined by (1 1 1) planes. The bases 1526 have an angle 1520 upward with respect to the surface 1408 in which the second trenches 1514 are formed, where the angle 1520 is equal to the cutting angle θ.

After fabrication of the slanted grating 1522, in some embodiments, the mask layer 1508 is removed, e.g., as described in reference to FIG. 11E.

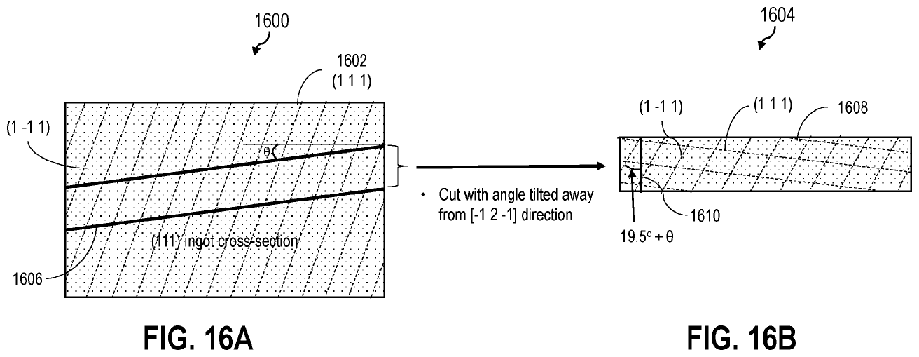

Similar methods can be used to fabricate slanted gratings with slant angles greater than 19.5° in substrates with diamond cubic crystal structures. As shown in FIGS. 16A-16B, an ingot 1600 having a (1 1 1) surface 1602 can be cut at a cutting angle θ away from a <2 −1 −1> direction, e.g., away from the [-1 2 −1] direction, opposite to the tilt direction of FIGS. 14A-14B. The slicing plane 1606 along which the ingot 1600 is sliced is the (1 1 1) plane tilted downward in the [−1 2 −1] direction. The cutting angle θ is θ>0. Accordingly, a substrate 1604 is obtained having a surface 1608 aligned with the slicing plane 1606, the surface 1608 having the cutting angle θ with respect to (1 1 1) planes. The normal direction 1610 to the surface 1608 forms an angle 19.5°+θ with the (1 −1 1) planes.

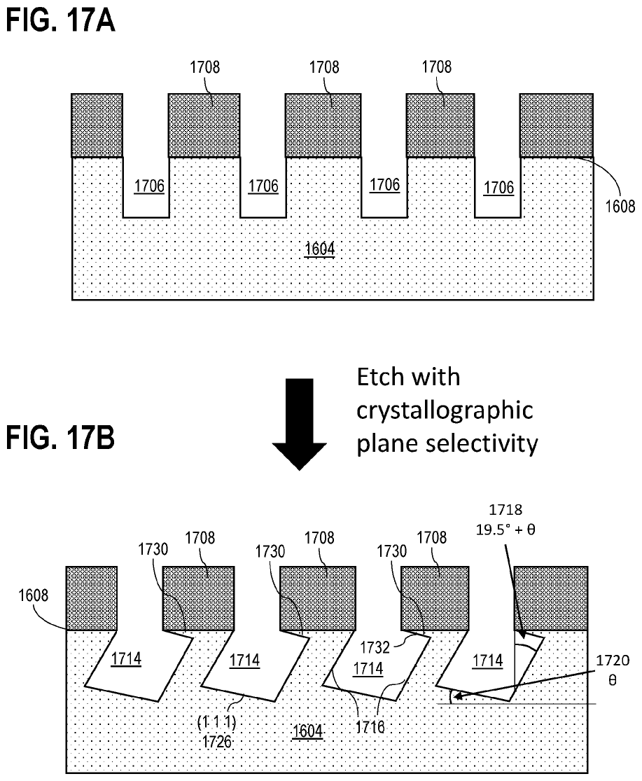

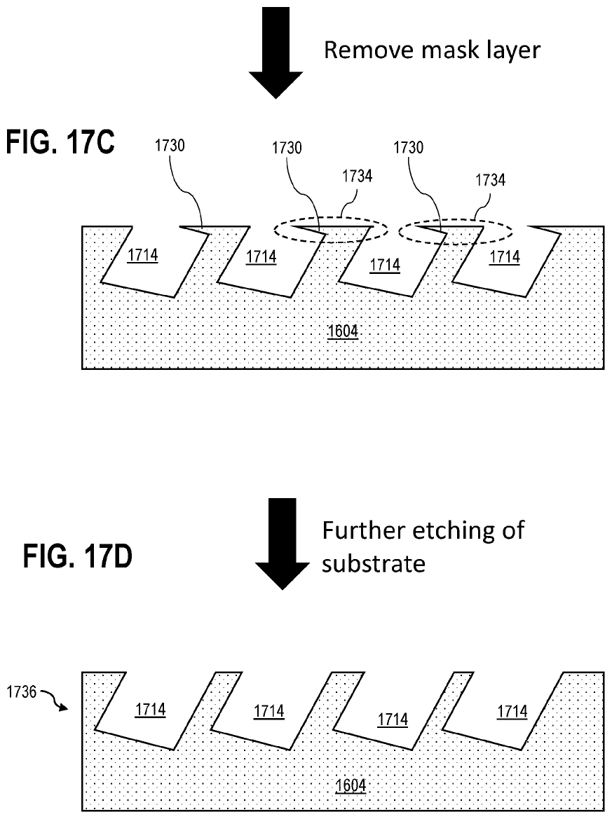

As shown in FIG. 17A, first trenches 1706 can be patterned in the substrate 1604, e.g., using a mask layer 1708 as described in reference to FIGS. 11A-11C. The first trenches 1706 are formed in the surface 1608 of the substrate 1604 (the surface 1608 having the angle θ with respect to the (1 1 1) plane). Elements of FIGS. 17A-17D can have characteristics as described for corresponding elements of FIGS. 11A-11E, except where noted otherwise.

As shown in FIG. 17B, the substrate 1604 is etched in an etch process for which the (1 −1 1) plane is a slow plane (e.g., an etch process as described in reference to FIG. 11D), such that second trenches 1714 are formed with sidewalls 1716 defined by (1 −1 1) planes. The second trenches 1714 have slant angles 1718 (defined as the sidewalls'angle with respect to a normal direction to the surface 1608) equal to 19.5°+θ. Bases 1726 of the second trenches 1714 are defined by (1 1 1) planes. The bases 1726 have an angle 1720 downward with respect to the surface 1608 in which the second trenches 1714 are formed, where the angle 1720 is equal to the cutting angle θ.

However, unlike in the case of FIGS. 15A-15B for obtaining slant angles <19.5°, in the example of FIGS. 17A-17B, cantilevers 1730 are formed under the mask layer 1708, with bottom surfaces 1732 of the cantilevers 1730 being defined by (1 1 1) planes. As shown in FIG. 17C, when the mask layer 1708 is removed, the cantilever 1730 remain above each second trench 1714. The cantilevers 1730, if not removed, may interfere with the desired optical operation of the slanted grating, e.g., cause light diffraction in undesired direction(s). The cantilevers 1730 may also interfere with a subsequent imprinting process in which the structure of FIG. 17C is used as a master template to imprint a slanted grating in a device substrate, such as a device substrate that is or includes a waveguide. For example, the cantilevers 1730 may make it difficult to separate the master template from the waveguide.

As shown in FIG. 17D, in some embodiments, the structure of FIG. 17C is further etched to remove the cantilevers 1730. For example, a plasma etch can be used to uniformly “trim down” the substrate 1604, e.g., removing uppermost portions of the substrate both within and exterior to the second trenches 1714, including portions 1734 that include the cantilevers 1730, while generally maintaining angular orientations of the sidewalls of the second trenches 1714. Accordingly, a slanted grating 1736 with slant angle 19.5°+θ, and without cantilevers, can be fabricated. However, the further etching to remove the cantilevers may distort dimensions of the second trenches 1714, e.g., may make the second trenches 1714 deeper or shallower. The further etching may instead or additionally roughen or otherwise degrade surfaces of the second trenches 1714, e.g., may cause the sidewalls and/or bases of the second trenches 1714 to have increased roughness.

FIGS. 18A-18C illustrate another example of a process for fabricating slanted gratings with slant angle greater than 19.5° and without cantilevers in diamond cubic materials. In some embodiments, this process does not include the uniform etch illustrated with FIG. 17D and, accordingly, may result in slanted gratings with improved morphology and/or more precisely-controlled dimensions.

FIG. 18A illustrates the same structure as shown in FIG. 17A, including first trenches 1706 formed in a substrate 1604 having a surface 1608 oriented at an angle θ away from the [−1 2 −1] direction with respect to the (1 1 1) plane. The first trenches 1706 are formed through holes in a mask layer 1708.

As shown in FIG. 18B, portions of the mask layer 1708 adjacent to at least one of the first trenches 1706 are removed. For example, portions 1804 of the mask layer 1708 between first trenches 1706 can be trimmed down by a width 1802 (e.g., in some embodiments, at least 10 nm). The width 1802 can be uniform for all first trenches 1706 or can vary between first trenches 1706. In some embodiments, the portions of the mask layer 1708 are removed in a lithographic process, e.g., including deposition of a resist layer, patterning of a resist layer, and etching away the portions of the mask layer 1708 using one or more appropriate etch processes. In some embodiments, the portions of the mask layer 1708 are removed in an isotropic etch process, such as an isotropic wet chemical etch process, which can, in some embodiments, be performed without additional lithography/patterning steps. For example, the structure of FIG. 18A can be briefly immersed in an etchant that etches the mask layer 1708 selectively compared to the substrate 1604 (such as an HF dip (e.g., in buffered oxide etch (BOE)) when the mask layer 1708 is an SiO₂ layer and the substrate 1604 is a silicon substrate). Although the resulting isotropic etch not only removes lateral portions 1804 of the mask layer 1708 but also etches down the top of the mask layer 1708, in some embodiments, the width 1802 that is to be removed is much smaller than a thickness of the mask layer 1708, such that the width 1802 can be removed in an isotropic etch while a substantial thickness of the mask layer 1708 remains.

Removal of the portions of the mask layer 1708 adjacent to the first trenches 1706 exposes fast planes of the substrate 1604 that would otherwise be masked by the mask layer 1708. Accordingly, when the substrate 1604 is etched with an etchant for which {1 1 1} planes are slow planes as shown in FIG. 18C (e.g., as described in reference to FIGS. 11D and 15B), second trenches 1814 are formed without cantilevers, the second trenches 1814 forming a slanted grating 1822. The second trenches 1814 have sidewalls 1816 defined by (1 −1 1) planes and bases 1826 defined by (1 1 1) planes. The slant angle 1818 of the second trenches 1814 is 19.5°+θ, and the bases 1826 are angled downward with respect to the surface 1608 of the substrate 1604. Widths 1830 and pitches 1832 of the second trenches 1814 are determined at least by dimensions of the portions of the mask layer 1708 that remain after removal of portions of the mask layer 1708 adjacent to the first trenches 1706.

In some embodiments, the mask layer 1708 can be subsequently removed from the slanted grating 1822, e.g., as described in reference to FIG. 11E.

Accordingly, by appropriate selection of the substrate 1604 having a surface at the angle θ to the (1 1 1) plane, a slanted grating 1822 having a desired slant angle greater than 19.5° can be fabricated in substrates with diamond cubic crystal structures. For example, in some embodiments the slant angle is between 19.5° and 80°.

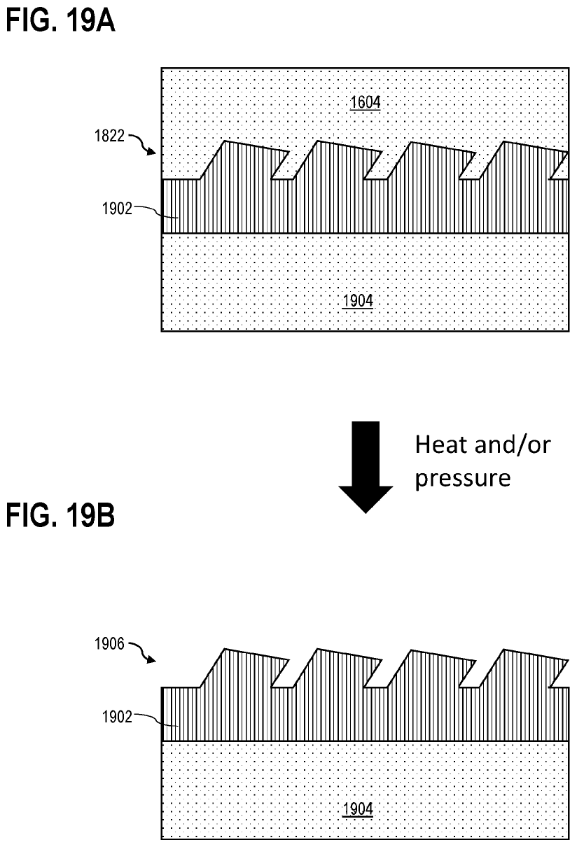

Once fabricated as described herein, slanted gratings in hard substrates (such as silicon substrates) can be used as master templates for fabrication of corresponding slanted gratings in other material(s), e.g., by nanoimprint lithography (NIL). As shown in FIGS. 19A-19B, a replication material 1902 (such as a polymer) disposed on a substrate 1904 is imprinted with the slanted grating 1822; the substrate 1604, in this example, is a master template substrate. The replication material 1902 and the substrate 1904 can be referred to collectively as a device substrate. In some embodiments, the substrate 1904 is not included under the replication material 1902. In some embodiments, the device substrate includes one or more waveguides, and the imprinted slanted grating can be arranged to in-couple and/or out-couple light into/from the one or more waveguides.

Heat and/or pressure are applied, and the slanted grating 1822 is removed, forming a surface relief structure 1906 that is itself a slanted grating, a negative of the slanted grating 1822. In some embodiments, the replication material is cured (e.g., cross-linked), e.g., by a thermal treatment and/or UV light. Based on appropriate selection of dimensions and slant angle of the slanted grating 1822, a corresponding slanted grating 1906 can be formed in the replication material 1902. The high uniformity and surface smoothness provided by the crystal-plane-defined slanted gratings described herein are transferred directly to the imprinted structures, such that the optical advantages described for slanted gratings fabricated as described herein are also provided to the imprinted structures.

Other imprint processes are also within the scope of this disclosure. For example, in some embodiments, the replication material that is to be imprinted is applied to the master template (e.g., including on the slanted grating pattern that is to be transferred), and the master template with the applied replication material is brought into contact with a substrate to transfer the replication material to the substrate with the transferred slanted grating pattern.

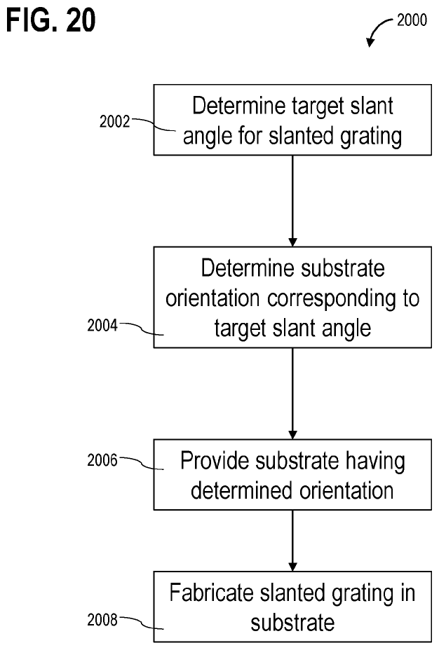

FIG. 20 illustrates an example of a process 2000 that can be performed according to some embodiments of this disclosure. In the process 2000, a target slant angle for a slanted grating is determined (2002). A substrate orientation corresponding to the target slant angle is determined (2004). For example, if the target slant angle is 19.5°, the determined substrate orientation can be a (1 1 1) orientation of a substrate having diamond cubic crystal structure. If the target slant angle is less than or greater than 19.5°, the determined substrate orientation can deviate from the (1 1 1) plane with an appropriate tilt angle and direction, as described herein.

A substrate having the determined orientation is provided (2006). For example, the substrate can be provided by slicing a (1 1 1) ingot at an appropriate angle, e.g., as described in reference to FIGS. 14A-14B and 16A-16B.

A slanted grating is fabricated in the substrate as described throughout this disclosure (2008). For example, periodic trenches can be patterned in a surface of the substrate, and sidewalls of the periodic trenches can be etched with an etch having crystallographic plane selectivity.

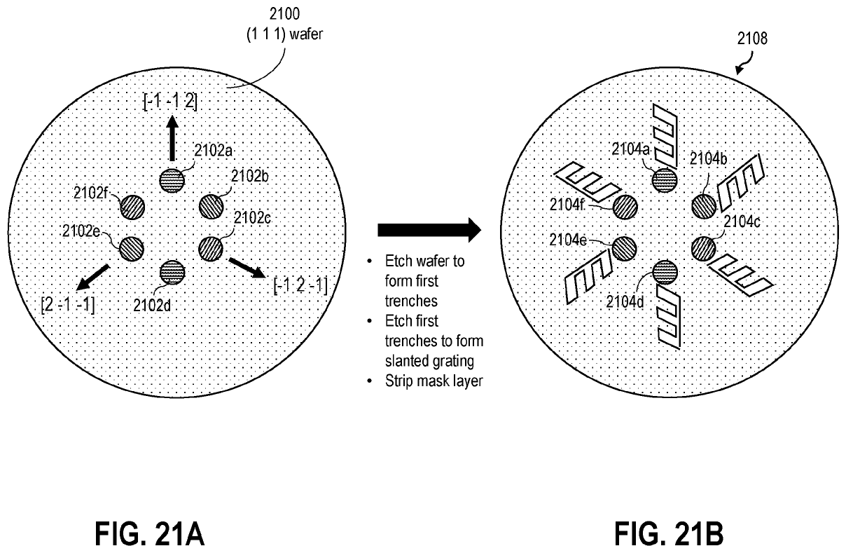

In some embodiments, crystal symmetries facilitate fabrication of multiple slanted gratings oriented in different directions in the same substrate. The substrate can have multiple slow planes that are equivalent to one another in the same crystal plane family, and the multiple slow planes can define sidewalls of different respective slanted gratings. As shown in FIG. 21A, a (1 1 1) silicon wafer 2100 is patterned with six mask layer patterns 2102a-2102f. Each mask layer pattern 2102 includes a set of elongated mask layer strips with gaps in-between, the set of elongated strips having an array direction and a perpendicular longitudinal direction. For example, a cross-section through a set of strips and the wafer 2100 can have a cross-section as shown in FIG. 11B.

The mask layer patterns 2102 are arranged to have array directions aligned with the three-fold symmetric crystal directions. Mask layer patterns 2102a and 2102d have array direction [−1 −1 2]; mask layer patterns 2102b and 2102e have array direction [2 −1 −1]; and mask layer patterns 2102c and 2102f have array direction [−1 2 −1]. Correspondingly, the extended strips of the mask layer have lengths extending in perpendicular [1 −1 0], [0 1 −1], and [−1 0 1] directions, respectively.

The wafer 2100 is etched to form first trenches (e.g., as described in reference to FIG. 11C), the first trenches are etched with an etchant that etches some crystal plane(s) faster than other crystal plane(s), to form slanted gratings (e.g., as described in reference to FIG. 11D), and the hard mask layer is removed (e.g., as described in reference to FIG. 11E). These etch processes can be performed for all mask layer patterns/first trenches in common, simultaneous etch processes, increasing fabrication efficiency. As a result, as shown in FIG. 21B, six slanted gratings 2104a-2104f are fabricated. Adjacent slanted grating patterns (included for illustrative purposes only) indicate respective slant directions of the slanted gratings 2104. The slanted gratings 2104 are oriented (in both slant direction/array direction (direction of widths of the second trenches that form the slanted gratings 2104) and in direction of extension of the lengths of the second trenches) in different directions, the different directions corresponding to both the three-fold symmetric [2 −1 −1] crystal directions and the patterning directions of the mask layer patterns 2102 that were arranged to align with the [2 −1 −1] directions. Specifically, slanted gratings 2104a and 2104d have array direction [−1 −1 2]; slanted gratings 2104b and 2104e have array direction [2 −1 −1]; and slanted gratings 2104c and 21024 have array direction [−1 2 −1]. Because the wafer 2100 is a (1 1 1) wafer, the slanted gratings 2104 have slant angle 19.5° with sidewalls defined by slow {1 1 1} planes. Accordingly, a master template 2108 is obtained having differently-oriented slanted gratings. The master template 2108 can be used to imprint corresponding differently-oriented slanted gratings in a device substrate, e.g., as described in reference to FIGS. 19A-19B.

Manufacturing throughput in some cases may be limited by a number of slanted grating patterns a device master template can imprint on a device substrate simultaneously. Advantageously, according to some embodiments of the fabrication processes described herein, a device master template can be configured to imprint a relatively high number of slanted diffraction grating patterns on the device substrate simultaneously, thereby allowing for relatively high manufacturing throughput of slanted diffraction gratings. For example, in some embodiments, a device master template includes slanted diffraction patterns that extend in multiple directions, e.g., at least partially in radial directions. For example, master template substrate 2108 includes six slanted gratings 2104, each having an array direction in a radial direction. Slanted gratings 2104a, 2104c, and 2104e have outwardly-radial array directions (slanted sidewalls tilted radially outwards), while slanted gratings 2104b, 2104d, and 2104f have inwardly-radial array directions (slanted sidewalls tilted radially inwards). Analogous processes (e.g., based on appropriate provision of mask layer patterns) can facilitate fabrication of other/additional slanted gratings on the master template substrate 2108. This allows for efficient usage of the area of the device master template for high throughput parallel imprinting of slanted diffraction patterns on device substrates such as waveguides.

A number of embodiments have been described. Nevertheless, it will be understood that various modifications may be made. Elements of one or more embodiments may be combined, deleted, modified, or supplemented to form further embodiments. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A method comprising:
patterning a plurality of first trenches in a surface of a substrate; and
etching the plurality of first trenches with an etchant having an etch rate for a first crystalline plane of the substrate that is greater than for a second crystalline plane of the substrate,
wherein the etching forms a slanted grating in the substrate.

2. The method of claim 1, wherein sidewalls of the slanted grating are defined by the second crystalline plane.

3. The method of claim 1, where bases of the slanted grating are defined by the second crystalline plane.

4. The method of claim 2, wherein the substrate has a diamond cubic crystal structure, and
wherein the second crystalline plane is a {1 1 1} plane of the diamond cubic crystal structure.

5. (canceled)

6. (canceled)

7. The method of claim 4, wherein the slanted grating is formed by a plurality of second trenches,
wherein the second trenches have a depth extending into the surface of the substrate, a width extending between two sidewalls defined by the {1 1 1} plane, and a length that is greater than the width, and
wherein the length extends parallel to a <1 1 0> direction of the diamond cubic crystal structure.

8. (canceled)

9. The method of claim 4, wherein the substrate comprises a (1 1 1)-oriented substrate, and wherein the sidewalls of the slanted grating have a slant angle of about 19.5° degrees.

10. The method of claim 4, wherein:
(1):
a normal direction to the surface of the substrate has a first angle of 19.5°−θ° with respect to the {1 1 1} plane of the diamond cubic crystal structure,
the sidewalls of the slanted grating have a slant angle equal to the first angle, and 0°<θ°<19.5°, or
(2):
a normal direction to the surface of the substrate has a first angle of 19.5°+θ° with respect to the {1 1 1} plane of the diamond cubic crystal structure, the sidewalls of the slanted grating have a slant angle equal to the first angle, and θ°>0.

11. (canceled)

12. The method of claim 4, wherein the surface of the substrate is sloped, with respect to a (1 1 1) plane of the diamond cubic crystal structure, in a <2 −1 −1> direction of the diamond cubic crystal structure.

13. The method of claim 1, wherein patterning the plurality of first trenches in the surface of the substrate comprises:
forming a mask on the surface of the substrate; and
anisotropically etching the substrate through openings in the mask, to form the plurality of first trenches.

14. The method of claim 13, wherein each trench of the plurality of first trenches has vertical sidewalls.

15.-16. (canceled)

17. The method of claim 13, comprising:
subsequent to patterning the plurality of first trenches, and prior to etching the plurality of first trenches, removing a portion of the mask adjacent to at least one first trench of the plurality of first trenches.

18. (canceled)

19. The method of claim 1, wherein the slanted grating has a pitch between 20 μm and 200 μm.

20.-22. (canceled)

23. A method comprising:
providing a master template substrate;
forming a slanted diffraction grating pattern in a surface of the master template substrate; and
using the master template substrate having the slanted diffraction grating pattern to imprint the slanted diffraction grating pattern on a device substrate.

24. The method of claim 23, wherein the master template substrate has a diamond cubic crystal structure, and wherein the slanted diffraction grating pattern is defined by a first {1 1 1} plane of the diamond cubic crystal structure.

25. The method of claim 24, comprising forming a second slanted diffraction grating pattern in the surface of the master template substrate, the second slanted diffraction grating pattern defined by a second {1 1 1} plane of the diamond cubic crystal structure, the second {1 1 1} plane different from the first {1 1 1} plane.

26. The method of claim 23, wherein sidewalls of the slanted diffraction grating pattern are defined by a crystalline plane of the master template substrate.

27. The method of claim 23, wherein the slanted diffraction grating pattern is a first slanted diffraction grating pattern, and wherein the method comprises:
forming a second slanted diffraction grating pattern in the surface of the master template substrate, wherein the first slanted diffraction grating pattern and the second slanted diffraction grating pattern have different array directions, and
using the master template substrate to imprint the second slanted diffraction grating pattern on the device substrate.

28.-33. (canceled)

34. An optical device, comprising:
a waveguide, and
a slanted grating defined in a surface of a substrate, the slanted grating arranged to direct light into the waveguide, wherein sidewalls of the slanted grating are defined by a crystalline plane of the substrate.

35. The optical device of claim 34, wherein the substrate has a diamond cubic crystal structure, and wherein the sidewalls are defined by a {1 1 1} plane of the diamond cubic crystal structure.

36. The optical device of claim 34, wherein the substrate includes the waveguide.

37.-40. (canceled)
